(19) United States
(12) Patent Application Publication
(10) Pub. No.: US 2025/0131342 A1
(43) Pub. Date: Apr. 24, 2025

(54) Machine Learning Based Overbooking Modeling

(71) Applicant: Oracle International Corporation, Redwood Shores, CA (US)

(72) Inventors: Andrew VAKHUTINSKY, Sharon, MA (US); Zijie ZHOU, Cambridge, MA (US)

(21) Appl. No.: 18/610,745

(22) Filed: Mar. 20, 2024

Related U.S. Application Data
(60) Provisional application No. 63/585,735, filed on Sep. 27, 2023.

(51) Int. Cl. G06Q 10/02; G06N 20/00; G06Q 50/12

(52) U.S. Cl. CPC G06Q 10/02; G06N 20/00; G06Q 50/12

(57) ABSTRACT

Embodiments optimize hotel room reservations for a hotel. For a first day of a plurality of future days, embodiments automatically determine, based on an objective function, an overbooking limit for each category of hotel rooms for the hotel, where the hotel includes a plurality of different room categories. Embodiments receive a first reservation request for the first day for a first category room. When the determined overbooking limit for the first category room has not been reached, embodiments accept the first reservation request. When the accepted first reservation request is being checked in to the hotel on the first day, embodiments automatically determine, based on the objective function, to reject the first reservation request, accept the first reservation request, or upgrade the first reservation request to a higher category room.

### CROSS REFERENCE TO RELATED APPLICATIONS

This application claims priority of U.S. Provisional Patent Application Ser. No. 63/585,735, filed on Sep. 27, 2023, the disclosure of which is hereby incorporated by reference.

### FIELD

One embodiment is directed generally to a computer system, and in particular to a computer system implementing machine learning based overbooking modeling.

### BACKGROUND INFORMATION

Revenue management is the process of dynamically adjusting prices of goods or services in response to changes in market conditions or changes in supply conditions. Revenue management processes were pioneered by the passenger airline industry and have been imitated by other industries such as cargo airlines, hotels, car rentals, shippers, advertisement brokers and others.

A very common application of revenue management relates to service providers who are taking reservations for “date-constrained services”. Date-constrained services involve the imposition of transaction-specific limits on the date when the buyer may use the services they purchase. Examples of such a restrictions include specified arrival and departure dates for an airline reservation as well as specified check-in and check-out dates for a hotel reservation. The time restrictions make it particularly difficult to estimate demand and then determine optimized pricing that maximizes revenue/profit for date-constrained services, especially in the hotel industry.

Hotel revenue management can be viewed as an extension of airline revenue management. While methodologies developed for hotels can often be adapted for airlines, the reverse is not always feasible. A primary distinction is the nature of hotel room bookings, which can span multiple days, allowing for the reuse of rooms. Consequently, room availability varies daily because certain rooms may be occupied by guests staying for extended periods. In contrast, the seat inventory in airlines remains consistent for each flight regardless of the class (e.g., first, business, or economy). Hence, the strategies and methodologies for hotel revenue management are inherently more intricate and demanding than those for airline revenue management.

### SUMMARY

Embodiments optimize hotel room reservations for a hotel. For a first day of a plurality of future days, embodiments automatically determine, based on an objective function, an overbooking limit for each category of hotel rooms for the hotel, where the hotel includes a plurality of different room categories. Embodiments receive a first reservation request for the first day for a first category room. When the determined overbooking limit for the first category room has not been reached, embodiments accept the first reservation request. When the accepted first reservation request is being checked in to the hotel on the first day, embodiments automatically determine, based on the objective function, to reject the first reservation request, accept the first reservation request, or upgrade the first reservation request to a higher category room.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Further, elements may not be drawn to scale.

FIG. 1 is an overview block diagram of a hotel reservation system in accordance to embodiments of the invention.

FIG. 2 is a block diagram of a computer server/system in accordance with an embodiment of the present invention.

FIG. 3 is a flow diagram of the functionality of the system of FIG. 2 when functioning as a hotel revenue management system that provides overbooking modeling as well as taking reservations and facilitating the check in process in accordance to embodiments.

FIG. 4 illustrates example booking limit decisions spanning an entire week in accordance to embodiments.

FIG. 5 illustrates example decisions for the service period on Day s in accordance to embodiments.

FIGS. 6-9 illustrate an example cloud infrastructure that can implement hotel chain operations 104 that can include overbooking modeling module 16 of FIG. 2 in accordance to embodiments.

### DETAILED DESCRIPTION

Embodiments generate and use a machine learning based model to determine a booking limit during a hotel reservation period, including a determination of a room overbooking limit for each hotel room category. Embodiments further use the model to determine, during a check-in period, when to assign a guest to a reserved room or upgrade a guest to a more premium room. The model maximizes an objective function, such as revenue or profits, when arriving at the decision.

Embodiments optimize per-category booking limits for a hotel property management system. Embodiments further jointly optimize the assignment of guests to room categories subject to the room category limits and minimizes the possibility of downgrading the hotel guests or denying them a room. Because there is always a non-zero probability of a guest canceling their reservation, the number of reservations can slightly exceed the number of rooms within the overbooking limits depending on the likelihood of cancellations. However, since the cancellation probability is always estimated with some limited accuracy, embodiments account for the limited accuracy of the estimation by implementing a “robust” optimization approach to guarantee the optimal solution for the worst-case scenario.

Embodiments model revenue management for a hotel by focusing on two primary decision-making stages. The first stage is during the reservation period, where a booking limit can be established that generally sets the maximum number of reservations that can be accepted for the day or any other time period. Once this quota is met, reservations are closed for further bookings. The second stage is during the service period (i.e., when customers arrive and attempt to check in to a hotel in response to a reservation). During this stage, each customer is allocated to the appropriate room based on their reservations. For example, if a customer has reserved a basic room, there are several options. The customer can be assigned to a basic room, securing the standard room revenue. The customer can be upgraded to a premium room, with the hotel receiving both the basic room rate plus an optional additional upgrade fee. Or the customer can be rejected or downgraded, which can result in significant revenue loss.

Therefore, modeling a hotel daily decision-making process is bifurcated. In embodiments, initially, a booking limit is set, which directly influences the day's demand. Once this demand materializes, embodiments then need to implement an optimal room assignment and upgrading strategy.

In general, a hotel manager can be faced with two pivotal decisions every day, one of which is determining the booking limit. A common practice is to slightly overbook room categories, allowing the booking limit to exceed the actual available inventory. This approach is driven by two main factors: (1) A certain number of reservations typically get canceled or result in no-shows during the service period; and (2) If the actual turnout surpasses the room inventory for one category, guests can be upgraded to another category where availability exceeds demand.

However, excessive overbooking can backfire. If a hotel is unable to accommodate guests due to extreme overbooking, the ensuing rejection costs can be steep-far higher than standard room revenues. This might entail relocating guests to other hotels and renegotiating rates, among other repercussions.

Setting an optimal booking limit presents a multifaceted challenge. First, when a customer makes a reservation, it is impossible to know their actual likelihood of showing up. Although machine learning methods offer predictions, they can sometimes carry significant margins of error. A less than robust methodology could result in substantial revenue loss. Second, the complexity extends beyond setting a booking limit for a single day. There is a need to anticipate and set limits for several upcoming days, as many customers book their reservations well in advance. Finally, each reservation might vary in the duration of stay, and without knowing the certainty of each guest's arrival, determining the booking limit for both the current and subsequent days becomes especially intricate.

Embodiments, in general, attempt to maximize revenue from bookings and upgrades, minimize the costs of downgrading and “walking” customers, and protect revenue in premium classes. Complicating factors that make these achievements difficult to implement, including random cancellations, parameter uncertainty, accounting for multiday stays, and non-linear room category hierarchy.

Reference will now be made in detail to the embodiments of the present disclosure, examples of which are illustrated in the accompanying drawings. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, components, and circuits have not been described in detail so as not to unnecessarily obscure aspects of the embodiments. Wherever possible, like reference numbers will be used for like elements.

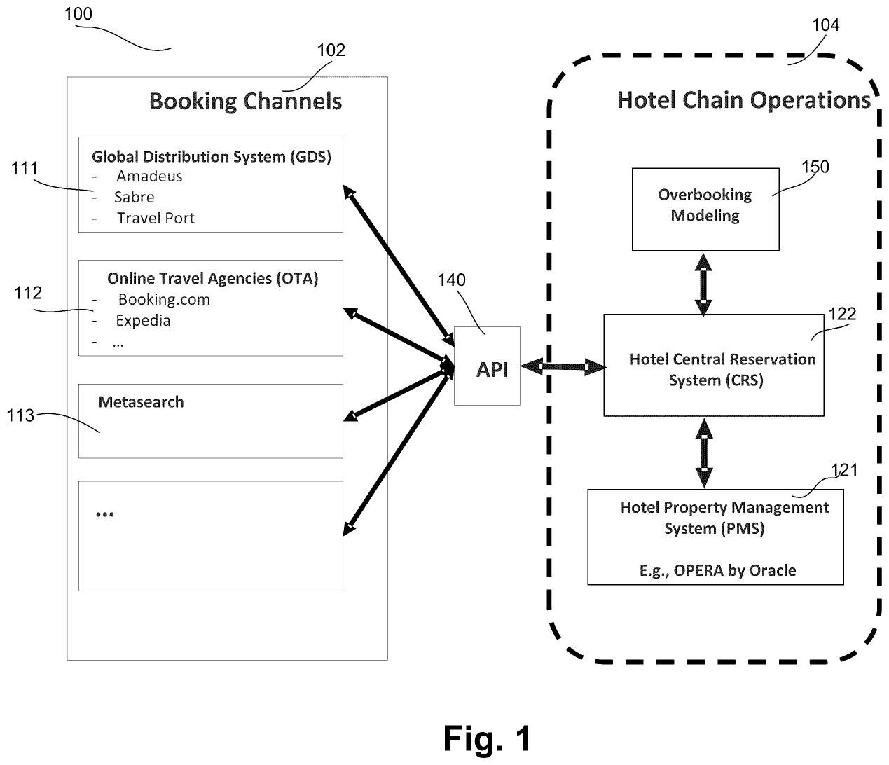

FIG. 1 is an overview block diagram of a hotel reservation system 100 in accordance to embodiments of the invention. FIG. 1 includes booking channels 102 that a potential hotel customer may interact with to reserve a hotel room. The channels include a Global Distribution System (“GDS”) 111, including “Amadeus”, “Sabre”, “Travel Port”, etc., Online Travel Agencies (“OTA”) 112, including “Booking.com”, “Expedia”, etc., Metasearch sites 113, and any other means for a customer to reserve a hotel room, including a website maintained by a hotel chain or individual hotel.

Each hotel chain operations 104 is accessed by an Application Programming Interface (“API”) 140 as a Web Service such as a “WebLogic Server” from Oracle Corp. Hotel chain operations 104 includes a Hotel Property Management System (“PMS”) 121, such as “OPERA Cloud Property Management” from Oracle Corp., a Hotel Central Reservation System (“CRS”) 122, and an Overbooking Modeling module 150 that interfaces with systems 121 and 122 to provide overbooking modeling, and all other functionality disclosed herein. Overbooking modeling also may interface with a hotel computer system to provide upgrade recommendations during the check in of a customer with a reservation. In embodiments, hotel chain operations 104 is implemented by a cloud based infrastructure. In one embodiment, the cloud based infrastructure comprises the “Oracle Cloud Infrastructure” (“OCI”) from Oracle Corp.

A hotel customer or potential hotel customer that uses system 100 to obtain a hotel room typically engages in a three stage booking process. First an area availability search is conducted. Multiple hotel chains are shown and hotel CRS 122 provides static data. The static data can include the min/max rate, available dates, etc.

If the booking customer selects a hotel, they go to the next step which is the property search, including a single hotel property, multiple rooms and rate plans. For the single hotel property, information may include room category description data, rate plan description and room price, each of which is shown in a specific order. The property search includes real-time availability data and results in the booking customer selecting a room. Once the room is selected, the final step is final booking and the reservation being guaranteed by a credit card or other form of payment.

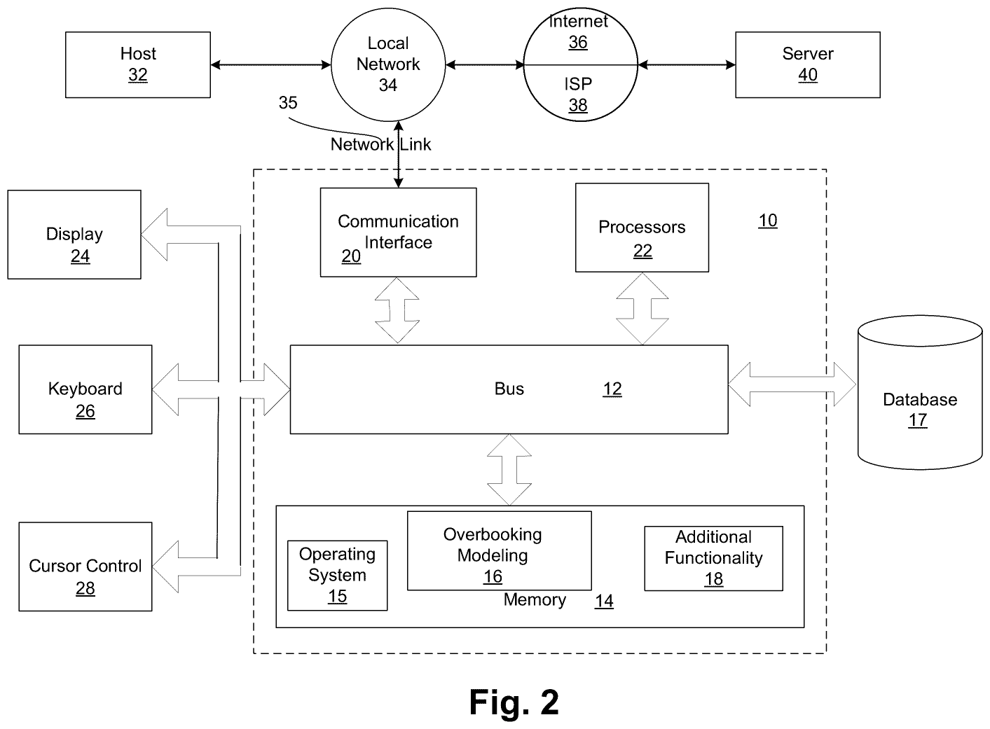

FIG. 2 is a block diagram of a computer server/system 10 in accordance with an embodiment of the present invention. Although shown as a single system, the functionality of system 10 can be implemented as a distributed system. Further, the functionality disclosed herein can be implemented on separate servers or devices that may be coupled together over a network. Further, one or more components of system 10 may not be included. For example, when implemented as a web server or cloud based functionality, system 10 is implemented as one or more servers, and user interfaces such as displays, mouse, etc. are not needed. In embodiments, system 10 can be used to implement any of the elements shown in FIG. 1.

System 10 includes a bus 12 or other communication mechanism for communicating information, and a processor 22 coupled to bus 12 for processing information. Processor 22 may be any type of general or specific purpose processor. System 10 further includes a memory 14 for storing information and instructions to be executed by processor 22. Memory 14 can be comprised of any combination of random access memory (“RAM”), read only memory (“ROM”), static storage such as a magnetic or optical disk, or any other type of computer readable media. System 10 further includes a communication device 20, such as a network interface card, to provide access to a network. Therefore, a user may interface with system 10 directly, or remotely through a network, or any other method.

Computer readable media may be any available media that can be accessed by processor 22 and includes both volatile and nonvolatile media, removable and non-removable media, and communication media. Communication media may include computer readable instructions, data structures, program modules, or other data in a modulated data signal such as a carrier wave or other transport mechanism, and includes any information delivery media.

Processor 22 is further coupled via bus 12 to a display 24, such as a Liquid Crystal Display (“LCD”). A keyboard 26 and a cursor control device 28, such as a computer mouse, are further coupled to bus 12 to enable a user to interface with system 10.

In one embodiment, memory 14 stores software modules that provide functionality when executed by processor 22. The modules include an operating system 15 that provides operating system functionality for system 10. The modules further include overbooking model module 16 that models overbooking to provide overbooking limits during the reservation process and upgrade recommendations during the check in process for hotel rooms, as well as additional functionality disclosed herein. System 10 can be part of a larger system. Therefore, system 10 can include one or more additional functional modules 18 to include the additional functionality, such as the functionality of a Property Management System (“PMS”) (e.g., the “Oracle Hospitality OPERA Property” or the “Oracle Hospitality OPERA Cloud Services”) or an enterprise resource planning (“ERP”) system. A database 17 is coupled to bus 12 to provide centralized storage for modules 16 and 18 and store guest data, hotel data, transactional data, etc. In one embodiment, database 17 is a relational database management system (“RDBMS”) that can use Structured Query Language (“SQL”) to manage the stored data.

In embodiments, communication interface 20 provides a two-way data communication coupling to a network link 35 that is connected to a local network 34. For example, communication interface 20 may be an integrated services digital network (“ISDN”) card, cable modem, satellite modem, or a modem to provide a data communication connection to a corresponding type of telephone line or Ethernet. As another example, communication interface 20 may be a local area network (“LAN”) card to provide a data communication connection to a compatible LAN. Wireless links may also be implemented. In any such implementation, communication interface 20 sends and receives electrical, electromagnetic or optical signals that carry digital data streams representing various types of information.

Network link 35 typically provides data communication through one or more networks to other data devices. For example, network link 35 may provide a connection through local network 34 to a host computer 32 or to data equipment operated by an Internet Service Provider (“ISP”) 38. ISP 38 in turn provides data communication services through the Internet 36. Local network 34 and Internet 36 both use electrical, electromagnetic or optical signals that carry digital data streams. The signals through the various networks and the signals on network link 35 and through communication interface 20, which carry the digital data to and from computer system 800, are example forms of transmission media.

System 10 can send messages and receive data, including program code, through the network(s), network link 35 and communication interface 20. In the Internet example, a server 40 might transmit a requested code for an application program through Internet 36, ISP 38, local network 34 and communication interface 20. The received code may be executed by processor 22 as it is received, and/or stored in database 17, or other non-volatile storage for later execution.

In one embodiment, system 10 is a computing/data processing system including an application or collection of distributed applications for enterprise organizations, and may also implement logistics, manufacturing, and inventory management functionality. The applications and computing system 10 may be configured to operate locally or be implemented as a cloud-based networking system, for example in an infrastructure-as-a-service (“IAAS”), platform-as-a-service (“PAAS”), software-as-a-service (“SAAS”) architecture, or other type of computing solution.

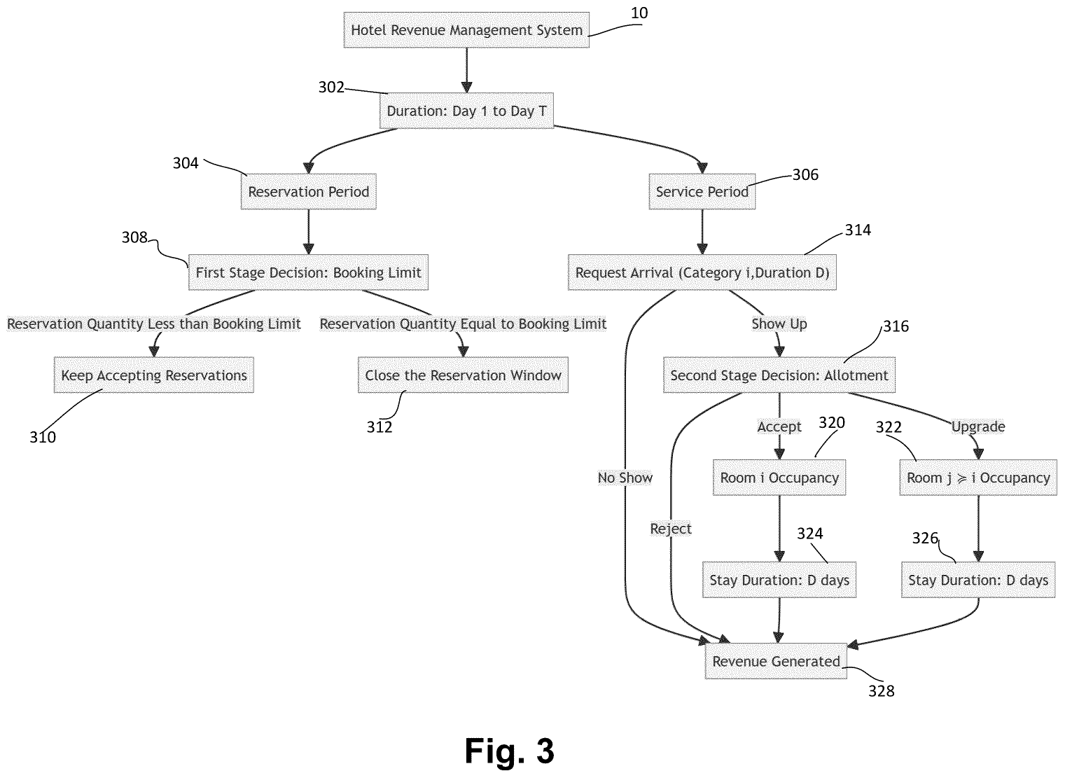

FIG. 3 is a flow diagram of the functionality of system 10 of FIG. 2 when functioning as a hotel revenue management system that provides overbooking modeling as well as taking reservations and facilitating the check in process in accordance to embodiments. In one embodiment, the functionality of the flow diagram of FIG. 3 is implemented by software stored in memory or other computer readable or tangible medium, and executed by a processor. In other embodiments, the functionality may be performed by hardware (e.g., through the use of an application specific integrated circuit (“ASIC”), a programmable gate array (“PGA”), a field programmable gate array (“FPGA”), etc.), or any combination of hardware and software. The functionality of FIG. 3 is disclosed for a hotel reservation system, but in other embodiments can be adapted to any date-constrained environment.

Embodiments implement assumptions regarding the benefits of overbooking, including that some reservations may not show up, and reservations can be upgraded to other room categories, as well as problems with overbooking, including a high “walking” cost, and revenue protection for other categories.

The functionality of FIG. 3 illustrates the business process of a hotel that is implemented by embodiments. For any hotel, the journey with a customer typically begins with a reservation: A customer selects a specific date, chooses a desired room category, and specifies the duration of their stay. Subsequently, on the chosen date of arrival, the customer may either check in at the front desk or opt to cancel their reservation in advance. In some instances, the customer might not show up, without a prior notice. For purposes of this disclosure, assume each hotel has three room categories, “basic”, “premium” and “suite”, where basic rooms are generally the cheapest and a suite is generally the most expensive.

Given this framework, the decision-making process for each day can be divided into two distinct parts, as shown in FIG. 3.

At 302, optimization in accordance to embodiments are implemented on a daily basis on a specific day s for every day from day 1 to day T(sϵ[1, T]) as reservations generally materialize with distinct, unpredictable no-show probabilities, and various lengths of stay. In other embodiments, the optimization can be more or less frequent than daily.

At 304, during the reservation period (i.e., as each reservation arrives at the hotel reservation system), embodiments at 308 make a first stage decision based on determined booking limits for each class of rooms. If the reservation quantity is less than the booking limit, then at 310 the reservation is accepted. If the reservation quantity is equal to the booking limit, then the reservation window is closed for that room category for that day or time period, except in the event of future cancellations during that time period.

At 306, during the service period (i.e., when a customer with a reservation arrives for check in), each request arrival for a room having category i for a duration D is evaluated. If the customer fails to show, the revenue (or lack of revenue) is determined at 328. If the customer arrives, embodiments at 316 makes a second stage decision regarding allotment of the reserved room. The customer will be offered a room category that was reserved at 320 and 324 or an upgraded room at 322 and 326, each of which, if accepted, impacts revenue (or other objective function). The model in accordance to embodiments used to implement the functionality of FIG. 3 is disclosed below.

In response to selecting/assigning an optimized specific room at and after 316, embodiments include transmitting specialized data (i.e., data specific to the selected room) to other specialized devices that use the data, such as using the data to automatically encode hotel room keys, using the data to automatically program hotel room door locks, etc.

### The Model

The model, in accordance to embodiments, for each day (or other time period), computes the booking limits for all room categories (i.e., the first stage 308 of FIG. 3), which will be used to make accept/reject decisions for new reservations that will arrive during the day (i.e., the second stage 316 of FIG. 3). Embodiments assume that there is a total of n room categories, and room category iϵ[n] has a total of cᵢ rooms. The daily revenue generated by room category i is rᵢ. Without loss of generality, it is assume that r₁<r₂< . . . <rₙ.

The expected revenue of upgrading from room category i to a higher or equivalent category j is given by Rᵢⱼ≥0. It is assumed that a hotel manager possesses the discretion to determine the upgrade policy for any incoming request upon its arrival at the front desk. Further, an upgrade need not solely transpire when inventory reaches capacity. As an illustration, even if the basic inventory remains available, it might still be optimal to upgrade a single-night basic request, especially if, based on predictions, there is a higher likelihood of subsequently receiving a five-night basic request, which could yield greater revenue. Regarding the anticipated upgrade price, Rᵢⱼ is invariably non-negative. A value of 0 denotes an involuntary upgrade, whereas a positive value indicates that customers incur an additional charge for the upgrade.

At the beginning of day s, embodiments have access to the following two sets of information: existing reservations (i.e., service period 306 of FIG. 3) and predicted new reservations (i.e., reservation period 304 of FIG. 3) that will arrive during day s.
1. Existing reservations: For each pair (t, t′) with t<s≤t′, let K^{(t,t′)} denote the number reservations made on day t for a stay that starts on day t′ (this only accounts for those reservations that have not yet been cancelled by the beginning of day s). The details of the k^{th} customer on the set K^{(t,t′)} are given by

$${I}_{k}^{( t , {t}^{′} )} = \{ {L}_{k}^{( t , {t}^{′} )} , {d}_{k}^{( t , {t}^{′} )} , {x}_{k}^{( t , {t}^{′} )} \} ,$$

where Lₖ^{(t,t′)} indicates the intended length of stay (in days) under the reservation, dₖ^{(t,t′)}=(dᵢₖ^{(t,t′)}) is a vector of binary variables with dᵢₖ^{(t,t′)}=1 means that the customer requested a room of category i (assuming that each customer requests exactly one room), and xₖ^{(t,t′)}=(xᵢⱼₖ^{(t,t′)}) is a vector of temporary room assignment. For each request for room category i in day t, at the time of the booking, embodiments make the following room assignment decision: to assign the customer to a room of category i, to assign the customer to a room of category j≥i (a free upgrade), or to deny the customer any room and incur a penalty. This decision is captured using binary variables {xᵢⱼₖ^{(t,t′)}}. Specifically,
a. xᵢᵢₖ^{(t,t′)}=1 and and xᵢⱼₖ^{(t,t′)}=0 for all j≠i means that the originally requested room category is assigned to the customer;
b. xᵢⱼₖ^{(t,t′)}=1 for some j [symbol] i and x_{ij′k}^{(t,t′)}=0 for all j′≠j means that the customer is upgraded to a room of category j (in this case, the customer will only be notified of this free upgrade at the time of the check-in);
c. xᵢⱼₖ^{(t,t′)}=0 for all j means that the customer will be denied any room, in which case the hotel incurs a penalty wᵢ^{(t′)}>0.

The aggregate data from existing reservations at the beginning of day s is captured by the following sigma field

$${I}_{existing}^{( s )} := {⋃}_{t = 1}^{s - 1} {⋃}_{{t}^{′} \geq s} {⋃}_{k = 1}^{{K}^{( t , {t}^{′} )}} {I}_{k}^{( t , {t}^{′} )} .$$

Let pₖ^{(t,t′)} denote the likelihood of the k^{th} customer on the set K^{(t,t′)} not showing up on day t′. It is assumed that the true probability pₖ^{(t,t′)} is estimated with a small error of +/−5 percentage points in embodiments. Therefore, when the cancellation probability is estimated at, for example, 20%, the uncertainty is set to the 15%-25% interval. Embodiments include a known convex uncertainty set [symbol] ^{(t,t′)} such that p^{(t,t′)}ϵ [symbol] ^{(t,t′)}, where p^{(t,t′)} is the vector consisting of pₖ^{(t,t′)} for all kϵK^{(t,t′)}. Since embodiments use a fixed 5% error, the uncertainty set becomes a hypercube in the |K^{(t,t′)}|-dimensional space.

The probability of each individual reservation is predicted using the following ML-based approach in one embodiment:

### Features (or Independent Variables:

Numerical features (including binary):
Booking window (how many days in advance the reservation is made)
Length of stay (stay days)
Days before arrival
Rate amount
Refundability as the number of days before check-in
Number of adults and children
Corporate discount
VIP status of the guest (yes/no)
Membership points or other accumulated reward level (if any)

Categorical features (encoded as one-hot numerical features):
Room category
Rate plan (rack, best available (BAR), breakfast included, etc.)
Booking channel with the following alternatives:
Online travel agency (OTA), e.g., Expedia
Global distribution system (GDS), e.g., Apollo
Hotel website or phone reservation system
Other
Additional categorical features are collected for the date of stay and include
Month of the year
Day of the week
Holiday or a special event

In embodiments, the dependent variable (output) is 0/1 indicating whether the reservation was cancelled. In embodiments, random forest is used in the classifier mode with each leaf of each decision tree in the ensemble has a 0/1 value to be selected as a prediction.

In embodiments, for model training, the training sample is constructed by replicating each existing reservation for each number of days before the check-in in the prediction horizon range. For example, if the reservation was booked 7 days in advance and cancelled 3 days in advance, then it will appear in the training sample 4 times for 7, 6, 5, 4 days in advance with the output 1 (i.e., canceled)

In embodiments, the cancellation probability prediction/estimation is obtained via a standard “predict_proba( )” method available in most known classifiers. In general, the probability is obtained as the proportion of individual decision trees predicting 1 as the output.
2. Predicted new reservations: In addition to the information related to existing reservations disclosed above, at the beginning of day s, embodiments also employ a prediction algorithm to predict additional reservations that could potentially be made on day s for stays that start on any day t≥s. In one embodiment, a machine learning (“ML”) algorithm is used to generate the prediction. Let R^{(s,t)} denote the predicted number of additional reservations made on day s for a stay that starts on day t. Similar to the above, for each kϵR^{(s,t)},

Iₖ^{(s,t)}:={\hat{L}ₖ^{(s,t)},\hat{d}ₖ^{(s,t)}},

where both \hat{L}ₖ^{(s,t)} and \hat{d}ₖ^{(s,t)} are also the outputs of the prediction algorithm. On each day s, for each future arriving day t, the embodiments predict the future reservations \hat{d}ₖ^{(s,t)} and their lengths \hat{L}ₖ^{(s,t)} using the following ML-based approach:

Training phase: For all historically observed pairs of days s and t, the following numerical statistics of the reservations existing on day s are collected: the number of reservations, their average booking window (how many days in advance the reservation is made), days before arrival (t-s), average refundability as the number of days before check-in, average numbers of adults and children in the reservations, average corporate discount, average VIP and loyalty statuses of the guests, as well as categorical values encoded as one-hot numerical values that are averaged over all reservations: room category; rate plan (rack, best available (“BAR”), breakfast included, etc.); Booking channel with the following alternatives: online travel agency (“OTA”), e.g., Expedia, global distribution system (“GDS”), e.g., Apollo, hotel website or phone reservation system; other categorical features are collected for the date of arrival and include month of the year, day of the week, holiday or a special event.

The model is trained separately for a specific prediction window (t-s) and for each room category, resulting in a collection of predictive models applied for a specific prediction window to predict the number of future reservations (dependent variable) booked for a specific room category. Embodiments use the Random Forest (“RF”) algorithm in the regressor mode. The most important variable is the number of existing reservations, indicating the volume of the demand for the hotel. The rest of the variables serve as a modulating factor essentially predicting the proportion of short booking window reservations by sensing among other factors a prevalence of business bookings vs. vacations that tend to have different booking windows. At the prediction phase, the trained RF model outputs the number of the future predicted reservations.

Similarly, another set of predictive models is used to estimate the average length of stay of the future reservations. These models use the same statistics and are also built separately for each prediction window and room category. Once the average length of stay is predicted, embodiments use a Poisson distribution to come up with the percentage of lengths of stay for each number of days as follows: p( [symbol] )=1+PoissonPMF(\hat{λ}ₖ^{st}−1, [symbol] ) where \hat{λ}ₖ^{st} is the predicted average length of stay and p( [symbol] ) is the fraction of stays with length [symbol] obtained based on probability mass function (“PMF”) of Poisson distribution with parameter \hat{λ}ₖ^{st}−1 to shift zero quantity to one-day length of stay. Finally, the percentages p( [symbol] ) are multiplied by the total number of predicted reservations \hat{K}^{(s,t)} and rounded off to match the total number of reservations. Since very limited information about the nature of the new reservations is available, the embodiments estimate the cancellation probabilities of the new reservations by running a simple linear regression on their lengths of stay as the only predicting feature using predicted cancellation probabilities for the existing reservations as the training sample.

For all trained predictive ML models disclosed above, one more of the models will be retrained in response to the passing of time when it is known how accurate the predictions were, such as the amount of new reservations received, the amount of reservations that are canceled in advance, etc.

The aggregate data for predicted reservations at the beginning of day s is given by

$${I}_{{predicted}^{}}^{( s )} = {⋃}_{t \geq s} {⋃}_{k = 1}^{{\hat{K}}^{( s , t )}} {\hat{I}}_{k}^{( s , t )} .$$

The likelihood of the k^{th} customer on the set \hat{K}^{(s,t)} canceling/not showing up on day t is unknown. As above, it is assumed that it belongs to a known convex uncertainty set [symbol] ^{(s,t)}.

To summarize, at the beginning of day s, embodiments have access to the following set of information:

I_{existing}^{(s)}∪I_{predicted}^{(s)}.

In the above, the \hat{ } (hat) symbol is used denote the outputs of the ML algorithm. For notational convenience, from this point onward, the hats are dropped from all notations. The meaning of each variable, whether it corresponds to information from existing reservations or an output of the prediction algorithm instead are clear from the time indices that appear in the superscript (since at the beginning of day s, any variable with superscript (s,t) for some t≥s corresponds to an output of the ML algorithm).

The pivotal decision that embodiments make at the beginning of day s is determining the Booking Limits {bᵢ^{(s,t)}}_{iϵ[N],t≥s}. Suppose that a reservation made on day s for a room of category j, intending to start the stay on day t and lasting for L days (with the condition that t≥s), is temporarily assigned to a room of category i (indicated by xⱼᵢₖ^{(s,t)}=1). This assignment can only be done (or is feasible) if, for each day s′ within the period from t to t+L (inclusive), the total number of checked-in reservations assigned to room category i on day s′ is less than the maximum capacity bᵢ^{(s,s′)} designated for category i. In other words, an assignment to a room category is feasible if and only if there is an available room of that category (according to the prescribed booking limits) for each day during the intended stay periods.

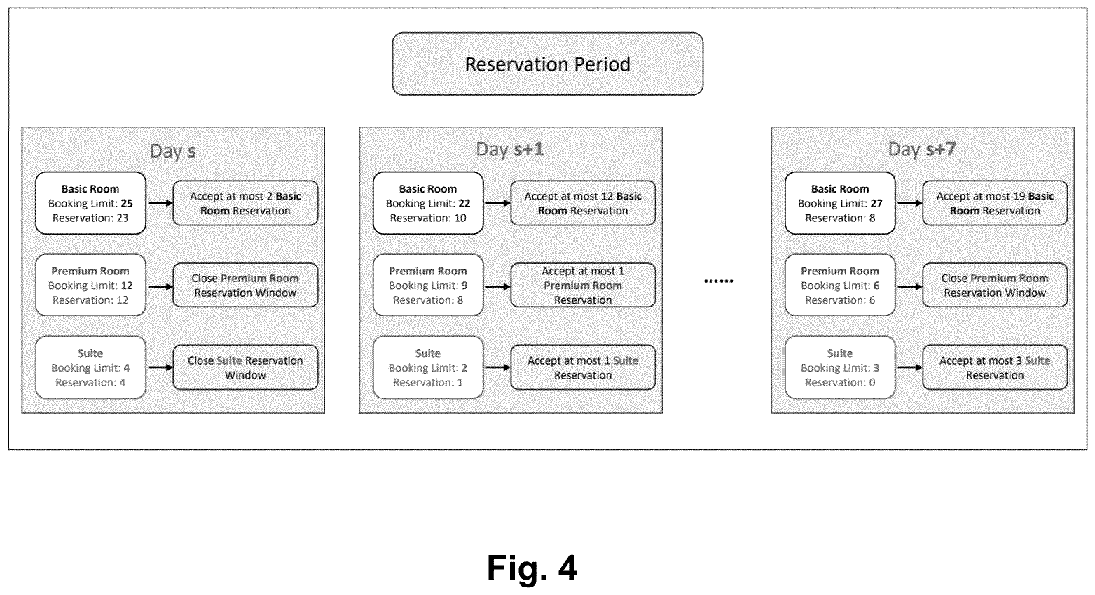

As disclosed, embodiments not only determine the booking limit for day “s”, but also establishes booking limits for each subsequent day. This stems from the realization that on any given day s, reservations might be made not just for that day but also for days s+1, s+2, and so on. Without proactive booking limits for future days, there is a risk of inadvertently overbooking on certain forthcoming dates. For example, if the optimal booking limit for premium rooms on day s+7 is fixed at 6 and there are already 6 uncancelled reservations in place, the hotel should then halt further reservations, indicating that this category is fully booked for day s+7. FIG. 4 illustrates example booking limit decisions spanning an entire week in accordance to embodiments.

For the service period (i.e., the second stage 316 of FIG. 3), as disclosed above, embodiments generate one of three potential decisions the k^{th} arriving customer:
(1) Allocate the arriving customer to the room category they originally requested and earn a revenue of rᵢ, namely xᵢᵢₖ^{(t,t′)}=1 and xᵢⱼₖ^{(t,t′)}=0 for all j≠i
(2) Upgrade to a more premium room category j for an additional non-negative fee Rᵢⱼ, namely xᵢⱼₖ^{(t,t′)}=1 for some j [symbol] i and x_{ij′k}^{(t,t′)}=0 for all j′≠j
(3) Reject the customer, incurring a significant rejection cost wᵢ^{(t′)}>0, namely xᵢⱼₖ^{(t,t′)}=0 for all j.

The complexity of this decision-making arises from the variable duration of each customer's stay. This variance implies that the problem cannot be succinctly addressed through linear programming alone; the different stay durations significantly influence the future availability of the designated rooms.

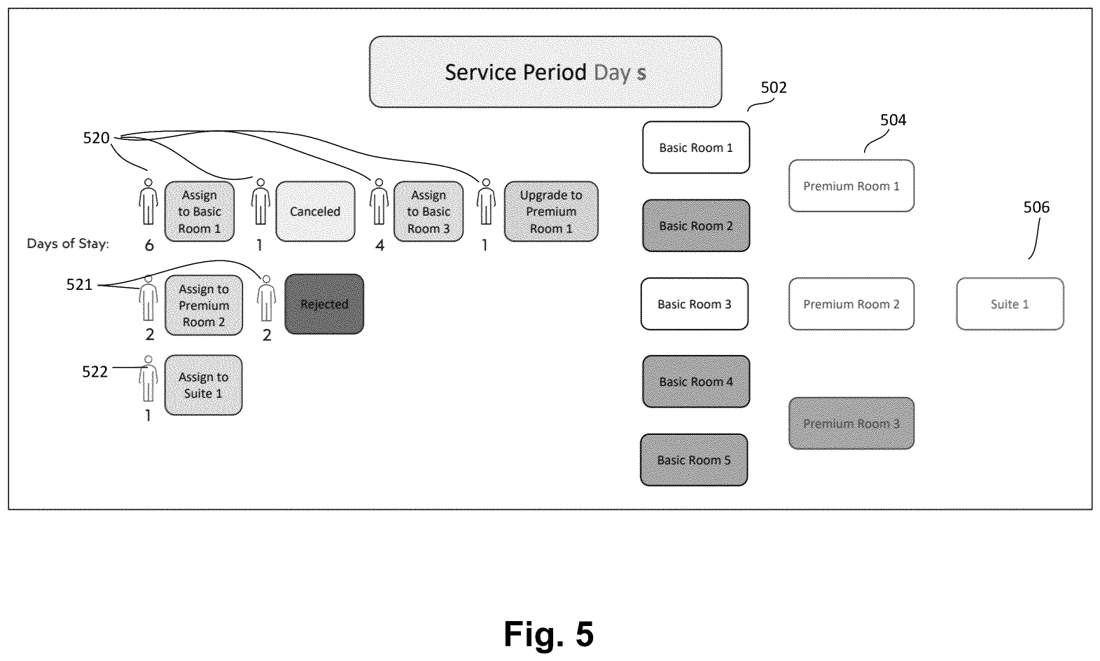

FIG. 5 illustrates example decisions for the service period on Day s in accordance to embodiments. Assume the hotel initially has 5 basic rooms (502), 3 premium rooms (504), and 1 suite (506). With rooms 2, 4, and 5 already occupied, perhaps due to previous multi-night reservations, only 2 basic rooms, 2 premium rooms, and 1 suite remain available. On the left, the diagram displays different customers: customers 520 represents those who requested basic rooms, customers 521 represent those seeking premium rooms, and customers 522 signifies suite requests. Not all customers with reservations may show up; some might cancel in advance. The primary challenge during the service period is to effectively match each arriving customer with the appropriate available room. The optimized assignments, determined by embodiments, is indicated in FIG. 5, including one of the customers seeking a premium room getting rejected.

### Optimization Formulation

Embodiments are implemented by an optimization model tailored for hotel revenue management on a given day sϵ[1, T], taking into account both multiple room types and multi-day bookings. The model is underpinned by a two-stage optimization structure. In the initial stage, the reservation stage, the core decision variables pertain to booking limits set for each room category. The subsequent stage, the service stage, introduces assignment decision variables, which delineate the room upgrade policy. Intrinsically adaptive, these variables pivot on actualized demand and cancellation patterns, thereby offering a dynamic response mechanism to real-world customer behavior. Specifically, embodiments factor in the worst-case scenarios of no-shows and cancellations, addressing them through robust optimization techniques.

Embodiments optimize decision-making that the hotel manager needs to solve at the beginning of each day in a rolling horizon manner. Specifically, at the beginning of day s, the hotel manager needs to compute the booking limits {bᵢ^{(s,t)}}_{iϵ[N]} for the next min {T′, T−s} days (i.e., tϵ[s, min{s+T′, T}]) by taking into account the existing reservations, the predicted new requests, the temporary assignment decisions, and the possibility of cancellation/no-shows. The objective is to maximize the expected worst-case revenue/profit during the next T′ days.

For s′ϵ[1, s] and tϵ[s, s+T′], let zₖ^{(s′,t)} be an independent Bernoulli, random variable with a success probability of 1−pₖ^{(t,t′)} (this is used as an indicator to denote no cancellation/no-show). For iϵ[N] and t≥s, let \tilde{c}ᵢ^{(s,t)} denote the number of rooms of category i that are occupied on day t due to reservations made before day s, which can be computed using the information set I_{existing}^{(s)}. Finally, define b^{(s)}, x^{(s)}, p^{(s)}, [symbol] ^{(s)} as follows:

$${b}^{( s )} := {\{ {b}_{i}^{( s , t )} \}}_{i ∈ [ N ] , t ∈ [ s , s + {T}^{′} ]} ,$$

$${x}^{( s )} := {\{ {x}_{ijk}^{( {s}^{′} , t )} \}}_{i ∈ [ N ] , j ∈ [ N ] , {s}^{′} ∈ [ 1 , s ] t ∈ [ s , s + {T}^{′} ]} ,$$

$${p}^{( s )} := {\{ {p}^{( {s}^{′} , t )} \}}_{k ∈ [ {K}^{( {s}^{′} , t )} ] , {s}^{′} ∈ [ 1 , s ] t ∈ [ s , s + {T}^{′} ]} ,$$

$${𝒫}^{( s )} := {\{ {𝒫}^{( {s}^{′} , t )} \}}_{{s}^{′} ∈ [ 1 , s ] , t ∈ [ s , s + {T}^{′} ]} .$$

The robust optimization formulation is given below:

### Objective

$${max}_{b , {x}^{( s , t )}} {\sum }_{t = s}^{s + {T}^{′}} 𝔼 [ \{ {min}_{p ∈ 𝒫 ( s , t )} {\sum }_{i = 1}^{n} ( {\sum }_{{s}^{′} = 1}^{s} {\sum }_{k = 1}^{{K}^{( {s}^{′} , t )}} {d}_{ik}^{( {s}^{′} , t )} {z}_{k}^{( {s}^{′} , t )} ( {\sum }_{j ≽ i} {r}_{i} {L}_{k}^{( {s}^{′} , t )} {x}_{ijk}^{( {s}^{′} , t )} ) - {w}_{i}^{( t )} max ( 0 , {\tilde{{c}_{ι}}}^{( t )} ( {𝒥}^{( s )} ) + {\sum }_{τ = s}^{s + {T}^{′}} {\sum }_{{s}^{′} = 1}^{s} {\sum }_{k = 1}^{{K}^{( {s}^{′} , τ )}} 1 ( τ \leq t \leq τ + {L}_{k}^{( {s}^{′} , τ )} - 1 ) {z}_{k}^{( {s}^{′} , τ )} ( {\sum }_{j ≼ i} {d}_{jk}^{( {s}^{′} , τ )} {x}_{jik}^{( {s}^{′} , τ )} - {\sum }_{j ≻ i} {d}_{ik}^{( {s}^{′} , τ )} {x}_{ijk}^{( {s}^{′} , τ )} ) - {c}_{i} ) \} ] \qquad ( 1 )$$

### Constraints

$${x}_{ijk}^{( s , t )} = \{ 0 , 1 \} , ∀ i ∈ [ n ] , j ≽ i , t ∈ \{ s , s + 1 , … , s + {T}^{′} \} , k ∈ [ {K}^{( s , t )} ]$$

$${\sum }_{{s}^{′} = 1}^{s} {\sum }_{k = 1}^{{K}^{( {s}^{′} , t )}} {d}_{ik}^{( {s}^{′} , t )} ( {\sum }_{j ≽ i} {x}_{ijk}^{( {s}^{′} , t )} ) \leq {b}_{i}^{( s , t )} , ∀ i ∈ [ n ] , t ∈ \{ s , s + 1 , … , s + {T}^{′} \}$$

$${\sum }_{j ≽ i} {x}_{ijk}^{( {s}^{′} , t )} \leq 1 , ∀ i ∈ [ n ] , t ∈ \{ s , s + 1 , … , s + {T}^{′} \} , k ∈ [ {K}^{( s , t )} ]$$

Fix tϵ[s, s+T′]. The terms in the objective of (1) can be split into two parts. The summation

$${\sum }_{i = 1}^{n} {\sum }_{{s}^{′} = 1}^{s} {\sum }_{k = 1}^{{K}^{( {s}^{′} , t )}} {d}_{ik}^{( {s}^{′} , t )} {z}_{k}^{( {s}^{′} , t )} ( {\sum }_{j ≽ i} {r}_{i} {L}_{k}^{( {s}^{′} , t )} {x}_{ijk}^{( {s}^{′} , t )} )$$

represents the total revenue from all uncancelled reservations that were made in the past for stays that start at day t. The second summation

$${\sum }_{i = 1}^{n} {w}_{i}^{( t )} max ( 0 {\tilde{, c}}_{l}^{( s , t )} + {\\ \sum }_{τ = s}^{s + {T}^{′}} {\sum }_{{s}^{′} = 1}^{s} {\sum }_{k = 1}^{{K}^{( {s}^{′} , τ )}} 1 ( τ \leq t \leq τ + {L}_{k}^{( {s}^{′} , τ )} − 1 ) {z}_{k}^{( {s}^{′} , τ )} ( {\sum }_{j ≼ i} {d}_{jk}^{( {s}^{′} , τ )} {x}_{jik}^{( {s}^{′} , τ )} − {\sum }_{j ≻ i} {d}_{ik}^{( {s}^{′} , τ )} {x}_{ijk}^{( {s}^{′} , τ )} ) − {c}_{i} )$$

represents the total penalty cost. To see this, note that, \tilde{c}ᵢ^{(s,t)} denotes the number of rooms of category i that are occupied on day t due to reservations made before day s, whereas the summation

$${\\ \sum }_{τ = s}^{s + {T}^{′}} {\sum }_{{s}^{′} = 1}^{s} {\sum }_{k = 1}^{{K}^{( {s}^{′} , τ )}} 1 ( τ \leq t \leq τ + {L}_{k}^{( {s}^{′} , τ )} − 1 ) {z}_{k}^{( {s}^{′} , τ )} ( {\sum }_{j ≼ i} {d}_{jk}^{( {s}^{′} , τ )} {x}_{jik}^{( {s}^{′} , τ )} - {\sum }_{j ≻ i} {d}_{ik}^{( {s}^{′} , τ )} {x}_{ijk}^{( {s}^{′} , τ )} )$$

represents the number of rooms of category i that are occupied on day t by customers who make their reservations since day s (these include customers who originally request a room of category i and are assigned a room of category i, and those who originally request a room of a lower category but are upgraded to category i; customers who originally request a room of category i but are upgraded to a higher category are not accounted).

Next, refer to the term min [symbol] , a principle underlying robust optimization. Given the significant costs associated with rejection, hotel managers are inclined towards more conservative decision-making to ensure minimal customer rejections in the check-in time, even in the most challenging scenarios. To accomplish this, an uncertainty set for the cancellation probability is defined. The set, denoted as [symbol] ^{(s,t)}, spans a K^{(s,t)}-dimensional region. Embodiments then focus on maximizing the revenue under the adversarial worst-case scenario.

All the constraints in the optimization formulation are self-explanatory:
The first constraint ensures the upgrading from room i to room j [symbol] is binary: either 1 (indicating an upgrade) or 0 (no upgrade).
The second constraint guarantees the number of requests during the reservation period does not exceed the established booking limit.
The third constraint mandates that an upgrade can be to at most one room category.

In general, the above robust mixed integer optimization problem is not amenable to traditional optimization solvers. These solvers fall short when the uncertainty is built on the parameters of the random variables. Constraints in the model include (1) Quantity of accepted reservations is less than the booking limit; (2) A request can be accepted only if it shows up; (3) Quantity of upgrading for each request is non-negative; (4) Quantity of upgrading is less than the number of rooms requested; and (5) For each day in the planning horizon, the number of occupied rooms in each class does not exceed the inventory. Of these constraints, numbers 2-5 include uncertainties. Therefore, embodiments solve this technical problem by converting the robust mixed integer optimization problem (equation (1) above) into a linear optimization problem.

In order to transform equation (1) above into a linear optimization problem, embodiments start by establishing a polyhedron uncertainty set for the total number of arriving customers, thereby eliminating the random variables present in equation (1). Subsequently, embodiments formulate the robust counterpart for every constraint that contains uncertainty.

### Polyhedron Uncertainty Set

Embodiments begin with the following concentration inequality:

Let (Xᵢ) be independent Bernoulli random variables. If [symbol] (|Xᵢ|≤c)=1, and [symbol] [Xᵢ]=μᵢ. Then, for any ϵ>0:

$$ℙ ( \vert {\sum }_{i = 1}^{n} ( {X}_{i} - {μ}_{i} ) \vert > n ϵ ) \leq 2 {e}^{- \frac{n {ϵ}^{2}}{2 {σ}^{2} + 2 c ∈ / 3}} ,$$

$$where$$

$${σ}^{2} = \frac{1}{n} {\sum }_{i = 1}^{n} Var ( {X}_{i} ) .$$

Note that zₖ^{(s,t)}˜Ber(1−pₖ^{(s,t)}). Since [symbol] (|zₖ^{(s,t)}≤1)=1, by Bernstein inequality,

$$\\ ℙ ( \vert {\sum }_{{s}^{′} = 1}^{s} {\sum }_{k = 1}^{{K}^{( {s}^{′} , t )}} {z}_{k}^{( {s}^{′} , t )} - {\sum }_{{s}^{′} = 1}^{s} {\sum }_{k = 1}^{{K}^{( {s}^{′} , t )}} ( 1 - {p}_{k}^{( {s}^{′} , t} ) ) \vert > {Γ}_{c} ) \leq 2 exp ( - \frac{{\sum }_{{s}^{′} = 1}^{s} {K}^{( {s}^{′} , t )} {( \frac{{Γ}_{t}}{{\sum }_{{s}^{′} = 1}^{s} {K}^{( {s}^{′} , t )}} )}^{2}}{2 {σ}^{2} + \frac{2 {Γ}_{c}}{3 {\sum }_{{s}^{′} = 1}^{s} {K}^{( {s}^{′} , t )}}} ) = 2 exp ( - \frac{\frac{{Γ}_{t}^{2}}{{\sum }_{{s}^{′} = 1}^{s} {K}^{( {s}^{′} , t )}}}{\frac{2}{{\sum }_{{s}^{′} = 1}^{s} {K}^{( {s}^{′} , t )}} {\sum }_{{s}^{′} = 1}^{s} {\sum }_{k = 1}^{{K}^{( {s}^{′} , t )}} ( {p}_{k}^{( {s}^{′} , t )} ( 1 - {p}_{k}^{( {s}^{′} , t )} ) ) + \frac{2 {Γ}_{c}}{3 {K}^{( {s}^{′} , t )}}} ) = 2 exp ( - \frac{{Γ}_{t}^{2}}{2 {\sum }_{{s}^{′} = 1}^{s} {\sum }_{k = 1}^{{K}^{( {s}^{′} , t )}} ( {p}_{k}^{( {s}^{′} , t )} ( 1 - {p}_{k}^{( {s}^{′} , t )} ) ) + 2 {Γ}_{t} / 3} ) .$$

For each day, the parameter Γₜ represents the desired confidence level. For instance, if a decision-maker seeks a highly conservative decision with 99% confidence, they might select Γₜ such that:

$${inf}_{p ∈ {𝒫}^{( {s}^{′} , t )} , ∀ {s}^{′} ∈ [ s ]} 2 exp ( − \frac{{Γ}_{t}^{2}}{2 ( {\sum }_{{s}^{′} = 1}^{s} ( {\sum }_{k = 1}^{K ( {s}^{′} , t )} ( {p}_{k}^{( {s}^{′} , t )} ( 1 − {p}_{k}^{( {s}^{′} , t )} ) ) + 2 {Γ}_{t} / 3} ) = 0.01 .$$

With this established, the uncertainty set Z^{(t)} can be defined for any tϵT as:

$${𝒵}^{( t )} = \{ 0 \leq {z}_{k}^{( s , t )} \leq 1 , ∀ k ∈ [ {K}^{( s , t )} ] , {E}_{t} - {Γ}_{t} \leq {\sum }_{{s}^{′} = 1}^{s} {\sum }_{k = 1}^{{K}^{( {s}^{′} , t )}} {z}_{k}^{( {s}^{′} , t )} \leq {E}_{t} + {Γ}_{t} \} , \qquad ( 2 )$$

where Eₜ=Σ_{s′=1}^{s}Σₖ₌₁^{K(s′,t)}(1−pₖ^{(s′,t)}) denotes the expected number of customers arriving during the service period on day t. Equation (2) implies that the total number of arriving customers on the day t should be proximate to its expected value.

Consequently, the adversary's choice can be redirected from determining the cancellation probability to selecting the arrival count. Therefore, the term min [symbol] in Optimization problem (1) can be replaced with min_{zϵZ}_{^{(t)}}:

### Robust Mixed Integer Programming

$${max}_{b , u , v , q , γ} {\sum }_{t = s}^{s + {T}^{′}} {γ}_{t} \qquad ( 3 )$$

subject to

$$γ \text{?} {min}_{z \text{?} 𝒵 \text{?}} {( \sum }_{i = 1}^{n} {\sum }_{k = 1}^{{K}^{( {s}^{′} , t )}} {d}_{ik}^{( {s}^{′} , t )} ( {\sum }_{j ⪰ i} {r}_{i} {L}_{k}^{( {s}^{′} , t )} {x}_{ijk}^{( {s}^{′} , t )} {z}_{k}^{( {s}^{′} , t )} ) - w \text{?} q \text{?} ) ,$$

$$∀ t ∈ \{ s , s + 1 , … , s + {T}^{′} \}$$

$${x}_{ijk}^{( {s}^{′} , t )} = \{ 0 , 1 \} ,$$

$$∀ i ∈ [ n ] , j ⪰ i , t ∈ \{ s , s + 1 , … , s + {T}^{′} \} , k ∈ [ {K}^{( s , t )} ]$$

$${\sum \text{?}}^{s} {\sum }_{k = 1}^{K} \text{?} {d}_{ik}^{( {s}^{′} , t )} ( {\sum }_{j ⪰ i} {x}_{ijk}^{( {s}^{′} , t )} ) \leq b \text{?} ,$$

$$∀ i ∈ [ n ] , t ∈ \{ s , s + 1 , … , s + {T}^{′} \}$$

$${\sum }_{j ⪰ i} {x}_{ijk}^{( s , t )} \leq 1 ,$$

$$∀ i ∈ [ n ] , t ∈ \{ s , s + 1 , … , s + {T}^{′} \} , k ∈ [ {K}^{( s , t )} ]$$

$$q \text{?} \geq 0 ,$$

$$∀ i ∈ [ n ] , t ∈ \{ s , s + 1 , … , s + {T}^{′} \}$$

$$\begin{matrix}q \text{?} \geq \tilde{c} \text{?} ( \text{?} ) + \sum \text{?} \sum \text{?} \sum \text{?} & 1 ( \text{?}\end{matrix} \leq t \text{?} \leq + L \text{?} - 1 ) ( {\sum }_{j ⪯ i} {d}_{jk}^{( {s}^{′} , τ )} {x}_{jik}^{( τ )} - {\sum }_{j ≻ i} {d}_{ik}^{( {s}^{′} , τ )} {x}_{ijk}^{( τ )} ) z \text{?} - {c}_{i} ,$$

$$∀ i ∈ [ n ] , t ∈ \{ s , s + 1 , … , s + {T}^{′} \} , z \text{?} ∈ 𝒵 \text{?}$$

$$\text{?} \text{indicates text missing or illegible when filed}$$

### Robust Counterpart

Embodiments relax xᵢⱼₖ^{(s,t)} to satisfy that 0≤xᵢⱼₖ^{(s,t)}≤1 for any i, j, k, s, t. Then, the sole factor preventing Optimization Problem (3) from being classified as linear programming lies in the uncertainty variables present within the first and sixth constraints, which are situated in the specified polyhedron uncertainty region. To address this, embodiments derive a linear formulation for each of these constraints.

### Fenchel Conjugate Function

Embodiments begin by providing the definition of the Fenchel conjugate: The Fenchel conjugate of a function ƒ is defined as:

$${f}^{*} ( y ) = {sup}_{x ∈ domain \int } ( {y}^{T} x - f ( x ) ) .$$

The conjugate function can be understood from the economic interpretation. Assume x is the quantity of a product, ƒ(x) is the cost to produce x units, y is the market price per unit, then y^{T}x is the revenue from sales of x units. Therefore, the conjugate function ƒ*(y) represents the optimal profit at a given price y.

Next, consider the conjugate of the following indicator function:

$$δ ( z \vert 𝒵 ) = \{ \begin{matrix}0 , & if z ∈ 𝒵 , \\ + ∞ , & if z ∉ 𝒵 ,\end{matrix}$$

Then, its Fenchel conjugate function is:

$${δ}^{*} ( y \vert 𝒵 ) = {sup}_{Z} \{ {y}^{T} z - δ ( z \vert Z ) \} = {sup}_{z ∈ Z} {y}^{T} z .$$

Consequently, the terms sup_{zϵZ}y^{T}z can be substituted by the conjugate function of the indicator function, δ*(y|Z). Additionally, given that the uncertainty set Z^{(t)} can be expressed as the intersection of two distinct sets: Z^{(t)}={0≤zₖ^{(s,t)}≤1, ∀kϵ[K^{(s,t)}]}∩{Γₜ−Eₜ≤Σₖ₌₁^{K}^{^{(s,t)}}zₖ^{(s,t)}≤Γₜ+Eₜ}, the following theorem can be invoked to simplify the conjugate function:
Theorem 1: Let Z₁, Z₂ be closed convex sets such that Z=Z₁∩Z₂, then

$${δ}^{*} ( z \vert 𝒵 ) = {min}_{{Z}_{1 ,} {Z}_{2}} \{ {δ}^{*} ( {z}_{1} \vert {𝒵}_{1} ) + {δ}^{*} ( {z}_{2} \vert {𝒵}_{2} ) \vert {z}_{1} + {z}_{2} = z \} .$$

Based on Theorem 1 above, the uncertainty set can be delineated as the intersection of two polyhedra, namely Z₁^{(t)}={0≤zₖ^{(s,t)}≤1, ∀kϵ[K^{(s,t)}]} and Z₂^{(t)}={Γₜ−Eₜ≤Σₖ₌₁^{K}^{^{(s,t)}}≤Γₜ+Γₜ}. The conjugate function for each polyhedron can be substantially computed. A lemma can also be presented that describes the conjugate function within a polyhedron uncertainty set:

Lemma 1: Let Z be a closed polyhedron within the form {A^{T}z≤a}, then:

$${δ}^{*} ( y \vert 𝒵 ) = {min}_{u : {A}^{T} μ = {y}^{T}} , {A}^{T} μ$$

The proof of Lemma 1 is as follows:

By the definition of the conjugate function:

$${δ}^{*} ( y \vert 𝒵 ) = {sup}_{z ∈ Z} {y}^{T} z .$$

Next, by Lagrangian duality:

$$\begin{matrix}{sup}_{z ∈ Z} {y}^{⊤} z = {sup}_{z} {min}_{μ \geq 0} {y}^{⊤} z + μ ( a - {A}^{⊤} z ) \\ = {min}_{μ \geq 0} {sup}_{z} {y}^{⊤} z + μ ( a - {A}^{⊤} z ) \\ = {min}_{μ : {A}^{⊤} μ = {y}^{⊤}} , {a}^{⊤} μ\end{matrix}$$

By Theorem 1 and Lemma 1, the conjugate function for the polyhedron uncertainty set (2) can be solved as follows:

$$\begin{matrix}{δ}^{*} ( y \vert {𝒵}^{( t )} ) = {sup}_{{z}^{( t )} ∈ {𝒵}^{( t )}} {min}_{{λ}_{1} , {λ}_{2} , v} \{ {y}^{⊤} {z}^{( t )} + {\sum }_{k} {u}_{k}^{( t )} {z}_{k}^{( s , t )} + {\sum }_{k} {v}_{k}^{( t )} ( 1 - {z}_{k}^{( s , t )} ) \\ + {λ}_{1} ( {Γ}_{t} + {E}_{t} - {\sum }_{k} {z}_{k}^{( s , t )} ) + {λ}_{2} ( {\sum }_{k} {z}_{k}^{( s , t )} - {E}_{t} + {Γ}_{t} ) \} \\ = {{min}_{{λ}_{1} , {λ}_{2} \geq 0 , {u}^{( t )} , {v}^{( t )} \geq 0 ,}}_{{λ}_{1} - {λ}_{2} + {v}_{k}^{( t )} = {y}_{k}^{( t )} + {u}_{k}^{( t )}} {\sum }_{k} {v}_{k}^{( t )} + ( {λ}_{1} - {λ}_{2} ) {E}_{t} + ( {λ}_{1} + {λ}_{2} ) {Γ}_{t} \\ = {{min}_{{λ}_{1} , {λ}_{2} \geq 0 , {v}^{( t )} \geq 0 ,}}_{{λ}_{1} - {λ}_{2} + {v}_{k}^{( t )} \geq {y}_{k}^{( t )}} {\sum }_{k} {v}_{k}^{( t )} + ( {λ}_{1} - {λ}_{2} ) {E}_{t} + ( {λ}_{1} + {λ}_{2} ) {Γ}_{t} .\end{matrix}$$

### Derive Robust Counterparts for Each Constraint Contain Uncertainty

The robust counterpart for each constraint that involves uncertain variables can now be determined. Delving into the details of constraints 1 and 6:

$${γ}_{t} \leq {min}_{{z}^{( t )} ∈ {𝒵}^{( t )}} {\sum }_{i = 1}^{n} ( {\sum }_{s ′ = 1}^{s} {\sum }_{k = 1}^{{K}^{( s ′ , t )}} {d}_{ik}^{( s ′ , t )} ( {r}_{i} {L}_{k}^{( s ′ , t )} {x}_{ijk}^{( s ′ , t )} {z}_{k}^{( s ′ , t )} ) - {w}_{i}^{( t )} {q}_{i}^{( t )} ) , \qquad Constraint 1$$

$$∀ t ∈ \{ s , s + 1 , … , s + {T}^{′} \}$$

First, multiply −1 on both sides:

$${max}_{{z}^{( t )} ∈ {𝒵}^{( t )}} {\sum }_{s ′ = 1}^{s} {\sum }_{k = 1}^{{K}^{( s ′ , t )}} {\sum }_{i = 1}^{n} - {d}_{ik}^{( s ′ , t )} ( {\sum }_{j ≽ i} {r}_{i} {L}_{k}^{( s ′ , t )} {x}_{ijk}^{( s ′ , t )} {z}_{k}^{( s ′ , t )} ) \leq - {γ}_{t} - {\sum }_{i = 1}^{n} {w}_{i}^{( t )} {q}_{i}^{( t )} ,$$

$$∀ t ∈ \{ s , s + 1 , … , s + {T}^{′} \} .$$

For each tΣ{s, s+1, . . . , s+T′}, embodiments define a diagonal matrix P^{(t)} where the non-zero element on the k^{th} row is Σ_{s′=1}^{s}Σᵢ₌₁ⁿ−dᵢₖ^{(s′,t)}Σ_{j≥i}rᵢLₖ^{(s′,t)}. Then, constraint 1 is equivalent as:

$${{max}_{{z}^{( t )} ∈ {𝒵}^{( t )}} ( {P}^{( t )} {z}^{( t )} )}^{T} {x}^{( s , t )} \leq - {γ}_{t} - {\sum }_{i = 1}^{n} {w}_{i}^{( t )} {q}_{i}^{( t )} .$$

By Equation (4) above, the robust counterpart is:

$${{{min}_{{λ}_{1}^{( t )} , {λ}_{2}^{( t )} \geq 0 , {v}_{1}^{( t )} \geq 0 ,}}_{{λ}_{1}^{( t )} - {λ}_{2}^{( t )} + {( {v}_{1}^{( t )} )}_{k} \geq }}_{{( {P}^{{( t )}^{⊤}} {x}^{( s , t )} )}_{k}} {\sum }_{k} {( {v}_{1}^{( t )} )}_{k} + ( {λ}_{1}^{( t )} - {λ}_{2}^{( t )} ) {E}_{t} + ( {λ}_{1}^{( t )} - {λ}_{2}^{( t )} ) {Γ}_{t} \leq - {γ}_{t} - {\sum }_{i = 1}^{n} {w}_{i}^{( t )}$$

$${q}_{i}^{( t )} \geq {\tilde{{c}_{ι}}}^{( t )} ( {𝒥}^{( s )} ) + {\sum }_{τ = s}^{s + {T}^{′}} {\sum }_{s ′ = 1}^{s} {\sum }_{k = 1}^{{K}^{( s ′ , τ )}} 1 ( τ \leq t \leq τ + {L}_{k}^{( s ′ , τ )} - 1 ) ( {\sum }_{j ≼ i} {d}_{jk}^{( s ′ , τ )} {x}_{jik}^{( τ )} - {\sum }_{j ≽ i} {d}_{ik}^{( s ′ , τ )} {x}_{ijk}^{( τ )} ) {z}_{k}^{( s ′ , τ )} - {c}_{i} , \qquad Constraint 6$$

$$∀ i ∈ [ n ] ,$$

$$t ∈ \{ s , s + 1 , … , s + {T}^{′} \} ,$$

$${z}^{( t )} ∈ {𝒵}^{( t )}$$

Deriving the robust counterpart of constraint 6 poses a challenge. For each tϵ{s, s+1, . . . , s+T′}, all the uncertainty sets Z^{(τ)} for τ≤t, must be considered, and Equation (4) is not applicable in this context. Thus, the robust counterpart is as follows: First, to simplify the notation, let S_{i,k,t}^{(s′,τ)}=1(τ≤t≤τ+Lₖ^{(s′,t)}−1)( [symbol] dⱼₖ^{(s′,τ)}xⱼᵢₖ^{(s′,τ)}−Σ_{j>i}dᵢₖ^{(s′,τ)}xᵢⱼₖ^{(s′,τ)}. Then, constraint 6 is equivalent as, for any iϵ[n], tϵ{s, s+1, . . . , s+T′},

$${\sum }_{τ = s}^{s + {T}^{′}} {\sum }_{s ′ = 1}^{s} {\sum }_{k = 1}^{{K}^{( s ′ , τ )}} {S}_{i , k , t}^{( s ′ , τ )} {z}_{k}^{( s ′ , τ )} \leq {q}_{i} + {c}_{i} - {\tilde{{c}_{ι}}}^{( t )} ( {𝒥}^{( s )} ) ,$$

$${z}^{( τ )} ∈ {𝒵}^{( τ )} ( ∀ τ \leq t ) ,$$

which implies that:

$${sup}_{{z}^{( τ )} ∈ {𝒵}^{( τ )} ( ∀ τ \leq t )} {\sum }_{τ = s}^{s + {T}^{′}} {\sum }_{s ′ = 1}^{s} {\sum }_{k = 1}^{{K}^{( s ′ , τ )}} {S}_{i , k , t}^{( s ′ , τ )} {z}_{k}^{( s ′ , τ )} \leq {q}_{i} + {c}_{i} - {\tilde{{c}_{ι}}}^{( t )} ( {𝒥}^{( s )} ) .$$

Next, the robust counterpart is derived for the left-hand side. By the definition of the uncertainty set (2), the left-hand side problem can be written as:

$${sup}_{{z}^{( τ )} ∈ {𝒵}^{( τ )} ( ∀ τ \leq t )} {\sum }_{τ = s}^{s + {T}^{′}} {\sum }_{s ′ = 1}^{s} {\sum }_{k = 1}^{{K}^{( s ′ , τ )}} {S}_{i , k , t}^{( s ′ , τ )} {z}_{k}^{( s ′ , τ )} \qquad ( 5 )$$

subject to:

$$0 \leq {z}_{k}^{( s ′ , τ )} \leq 1 ,$$

$$∀ τ \leq t ,$$

$$k ∈ [ {K}^{( s ′ , τ )} ]$$

$${E}_{τ} - {Γ}_{τ} \leq {\sum }_{s ′ = 1}^{s} {\sum }_{k = 1}^{{K}^{( s ′ , τ )}} {z}_{k}^{( s ′ , τ )} \leq {E}_{τ} + {Γ}_{τ} ,$$

$$τ \leq t$$

The Lagrangian duality of (5) is derived as follows:

$${min}_{{λ}_{3}^{( τ )} , {λ}_{4}^{( τ )} \geq 0 , {v}^{( τ )} , {λ}_{6}^{( τ )} \geq 0} {sup}_{z} {\sum }_{τ = s}^{s + {T}^{′}} {\sum }_{s ′ = 1}^{s} {\sum }_{k = 1}^{{K}^{( s ′ , τ )}} {S}_{i , k , t}^{( s ′ , τ )} {z}_{k}^{( s ′ , τ )} + {\sum }_{τ = s}^{s + {T}^{′}} {\sum }_{s ′ = 1}^{s} {\sum }_{k = 1}^{{K}^{( s ′ , τ )}} {v}^{( τ )} {z}_{k}^{( s ′ , τ )} + {v}_{6}^{( τ )} ( 1 - {z}_{k}^{( s ′ , τ )} ) + {\sum }_{τ = s}^{s + {T}^{′}} {\sum }_{s ′ = 1}^{s} {λ}_{3}^{( τ )} [ {\sum }_{k = 1}^{{K}^{( s ′ , τ )}} {z}_{k}^{( s ′ , τ )} - {E}_{τ} + {Γ}_{τ} ] + {\sum }_{τ = s}^{s + {T}^{′}} {\sum }_{s ′ = 1}^{s} {λ}_{4}^{( τ )} [ {E}_{τ} + {Γ}_{τ} - {\sum }_{k = 1}^{{K}^{( s ′ , τ )}} {z}_{k}^{( s ′ , τ )} ]$$

To simplify, the Lagrangian duality of (5) is equivalent as:

$${min}_{{λ}_{3}^{( τ )} , {λ}_{4}^{( τ )} \geq 0 , {v}^{( τ )} \geq 0} {\sum }_{τ = s}^{s + {T}^{′}} {\sum }_{s ′ = 1}^{s} {\sum }_{k = 1}^{{K}^{( s ′ , τ )}} {v}^{( τ )} - {\sum }_{τ = s}^{s + {T}^{′}} {\sum }_{s ′ = 1}^{s} {λ}_{3}^{( τ )} ( {E}_{τ} - {Γ}_{τ} ) + {\sum }_{τ = s}^{s + {T}^{′}} {\sum }_{s ′ = 1}^{s} {λ}_{4}^{( τ )} ( {E}_{τ} + {Γ}_{τ} )$$

subject to:

$${S}_{i , k , t}^{( s ′ , τ )} \leq {v}^{( τ )} + {λ}_{4}^{( τ )} - {λ}_{3}^{( τ )} ,$$

$$∀ i ∈ [ n ] ,$$

$${s}^{′} ∈ [ s ] ,$$

$$τ \leq t ,$$

$$k ∈ [ {K}^{( s ′ , τ )} ]$$

Therefore, the robust counterpart of Constraint 6 is:

$${\sum }_{τ = s}^{s + {T}^{′}} {\sum }_{s ′ = 1}^{s} {\sum }_{k = 1}^{{K}^{( s ′ , τ )}} {v}^{( τ )} - {\sum }_{τ = s}^{s + {T}^{′}} {\sum }_{s ′ = 1}^{s} {λ}_{3}^{( τ )} ( {E}_{τ} - {Γ}_{τ} ) + {\sum }_{τ = s}^{s + {T}^{′}} {\sum }_{s ′ = 1}^{s} {λ}_{4}^{( τ )} ( {E}_{τ} + {Γ}_{τ} ) \leq {q}_{i}^{( t )} + {c}_{i} - {\tilde{{c}_{ι}}}^{( t )} ( {𝒥}^{( s )} ) ,$$

$$∀ i ∈ [ n ]$$

$${v}^{( τ )} + {λ}_{4}^{( τ )} - {λ}_{3}^{( τ )} \geq {S}_{i , k , t}^{( s ′ , τ ) ,} ,$$

$$∀ i ∈ [ n ] ,$$

$${s}^{′} ∈ [ s ] ,$$

$$τ \leq t ,$$

$$k ∈ [ {K}^{( s ′ , τ )} ]$$

$${λ}_{3}^{( τ )} , {λ}_{4}^{( τ )} \geq 0 ,$$

$$∀ τ \leq t$$

$${v}^{( τ )} \geq 0 ,$$

$$∀ τ \leq t$$

### Linear Optimization Counterpart

With the results above, the linear optimization which is approximately equivalent to (1) can be written as:

$${max}_{b , x , q , γ , v , {λ}_{i} , i ∈ [ 4 ]} {\sum }_{t = s}^{s + {T}^{′}} {γ}_{t} \qquad ( 6 )$$

$$subject to$$

$${\sum }_{k} {( {v}_{1}^{( t )} )}_{k} + ( {λ}_{1}^{( t )} - {λ}_{2}^{( t )} ) {E}_{t} + ( {λ}_{1}^{( t )} + {λ}_{2}^{( t )} ) {Γ}_{t} \leq - {γ}_{t} - {\sum }_{i = 1}^{n} {w}_{i}^{( t )} {q}_{i}^{( t )} ,$$

$$∀ t ∈ \{ s , s + 1 , … , s + {T}^{′} \}$$

$$0 \leq {x}_{ijk}^{( s , t )} \leq 1 ,$$

$$∀ i ∈ [ n ] ,$$

$$j ≽ i ,$$

$$t ∈ \{ s , s + 1 , … , s + {T}^{′} \} ,$$

$$k ∈ [ {K}^{( s , t )} ]$$

$${\sum }_{s ′ = 1}^{s} {\sum }_{k = 1}^{{K}^{( s ′ , t )}} {d}_{ik}^{( s ′ , t )} ( {\sum }_{j ≽ i} {x}_{i j k}^{( s ′ , t )} ) \leq {b}_{i}^{( t )} ,$$

$$∀ i ∈ [ n ] ,$$

$$t ∈ \{ s , s + 1 , … , s + {T}^{′} \}$$

$${\sum }_{j ≽ i} {x}_{ijk}^{( s , t )} \leq 1 ,$$

$$∀ i ∈ [ n ] ,$$

$$t ∈ \{ s , s + 1 , … , s + {T}^{′} \} ,$$

$$k ∈ [ {K}^{( s , t )} ]$$

$${q}_{i}^{( t )} \geq 0 ,$$

$$∀ i ∈ [ n ] ,$$

$$t ∈ \{ s , s + 1 , … , s + {T}^{′} \}$$

$${\sum }_{τ = s}^{s + {T}^{′}} {\sum }_{s ′ = 1}^{s} {\sum }_{k = 1}^{{K}^{( s ′ , τ )}} {v}^{( τ )} - {\sum }_{τ = s}^{s + {T}^{′}} {\sum }_{s ′ = 1}^{s} {λ}_{3}^{( τ )} ( {E}_{τ} - {Γ}_{τ} ) + {\sum }_{τ = s}^{s + {T}^{′}} {\sum }_{s ′ = 1}^{s} {λ}_{4}^{( τ )} ( {E}_{τ} + {Γ}_{τ} ) \leq {q}_{i}^{( t )} + {c}_{i} - {\tilde{{c}_{ι}}}^{( t )} ( {𝒥}^{( s )} ) ,$$

$$∀ i ∈ [ n ] ,$$

$$t ∈ \{ s , s + 1 , … , s + {T}^{′} \} ,$$

$$τ \leq t$$

$${λ}_{1}^{( t )} - {λ}_{2}^{( t )} + {( {v}_{1}^{( t )} )}_{k} \geq {( {P}^{{( t )}^{⊤}} {x}^{( s , t )} )}_{k} ,$$

$$∀ t ∈ \{ s , s + 1 , … , s + {T}^{′} \} ,$$

$$k ∈ [ {K}^{( s , t )} ]$$

$${v}^{( τ )} + {λ}_{4}^{( τ )} - {λ}_{3}^{( τ )} \geq {S}_{i , k , t}^{( s ′ , τ , )} ,$$

$$∀ i ∈ [ n ] ,$$

$${s}^{′} ∈ [ s ] ,$$

$$t ∈ \{ s , s + 1 , … , s + {T}^{′} \} ,$$

$$k ∈ [ {K}^{( s , t )} ] ,$$

$$τ \leq t$$

$${v}^{( t )} \geq 0 ,$$

$$∀ t ∈ \{ s , s + 1 , … , s + {T}^{′} \}$$

$${λ}_{i}^{( t )} \geq 0 ,$$

$$∀ t ∈ \{ s , s + 1 , … , s + {T}^{′} \} ,$$

$$i ∈ [ 4 ]$$

### Pseudocode for Overbooking Optimization

Embodiments of the invention can be implemented using the following pseudocode/algorithm/heuristic designed to determine the booking limit for each day over the time horizon [1, T]:

```
Input: Period T′; confidence level α.
Output: Booking limits on Day s: bᵢ^{t} t ∈ {s, s + 1, ... , s + T′}.
for s ∈ {1, 2, ... , T}:
  for t ∈ {s, s + 1, ... , s + T′}:
    find Γₜ from the following equation:
${inf}_{p ∈ 𝒫 ( s , t )} 2 exp ( - \frac{{Γ}_{t}^{2}}{2 {\sum }_{k = 1}^{{K}^{( s , t )}} ( {p}_{k}^{( s , t )} ( 1 - {p}_{k}^{( s , t )} ) ) + 2 {Γ}_{t} / 3} ) = 1 - α \qquad ( 7 )$
  for all i ∈ [n], t ∈ {s, s + 1, ... , s + T′}:
      solve Optimization (6) with Γₜ
return optimal booking limit bᵢ^{(t)}
end
```

The above pseudocode requires an input defining the period, T′. For each day, denoted as s, the pseudocode recommends booking limits for the sequence of days: s, s+1, . . . , s+T′. A higher value for T′ offers better protection against extreme cases; however, this also exponentially raises the computational cost. In practical applications, embodiments may set T′=7, which means embodiments are determining booking limits for an entire week. The pseudocode also requires an input for the confidence level, a. This value represents the degree of conservatism the manager desires in decision-making. In embodiments, the confidence level is assigned as a=95%.

On day s, embodiments first predict the information of future requests, I_{predicted}^{(s)}. Combined with the information of all existing requests, I_{existing}^{(s)}, the hotel manager has access to the following set of information I_{existing}^{(s)}∪I_{predicted}^{(s)}. As disclosed above, embodiments construct an uncertainty set for the overall number of arrivals. The size of this set varies based on the confidence level a. A higher confidence level results in a larger uncertainty set. To ensure with high certainty that the total number of arrivals falls within the set, the set must be sufficiently large to encompass a majority of possible scenarios. Using this framework, embodiments determined the value of Γₜ for tϵ{s, s+1, . . . , s+T′}, as illustrated in Equation (7). Once equipped with I^{(s+T′)} and Γₜ, embodiments proceed to solve the linear optimization (6).

The optimal solution for the booking limit is denoted as bᵢ^{(t)}, where i spans all room categories, represented by iϵ[n], and t encompasses the range s, s+1, . . . , s+T′. These booking limits are subject to daily updates. If the number of reservations for a room in category i matches the booking limit on day t, the reservation window for that day is closed. Moreover, should the subsequent day's optimal booking limit for room category i on day t be equivalent to or smaller than the present limit, the reservation window remains closed. Otherwise, it will be reopened.

### Example Cloud Infrastructure

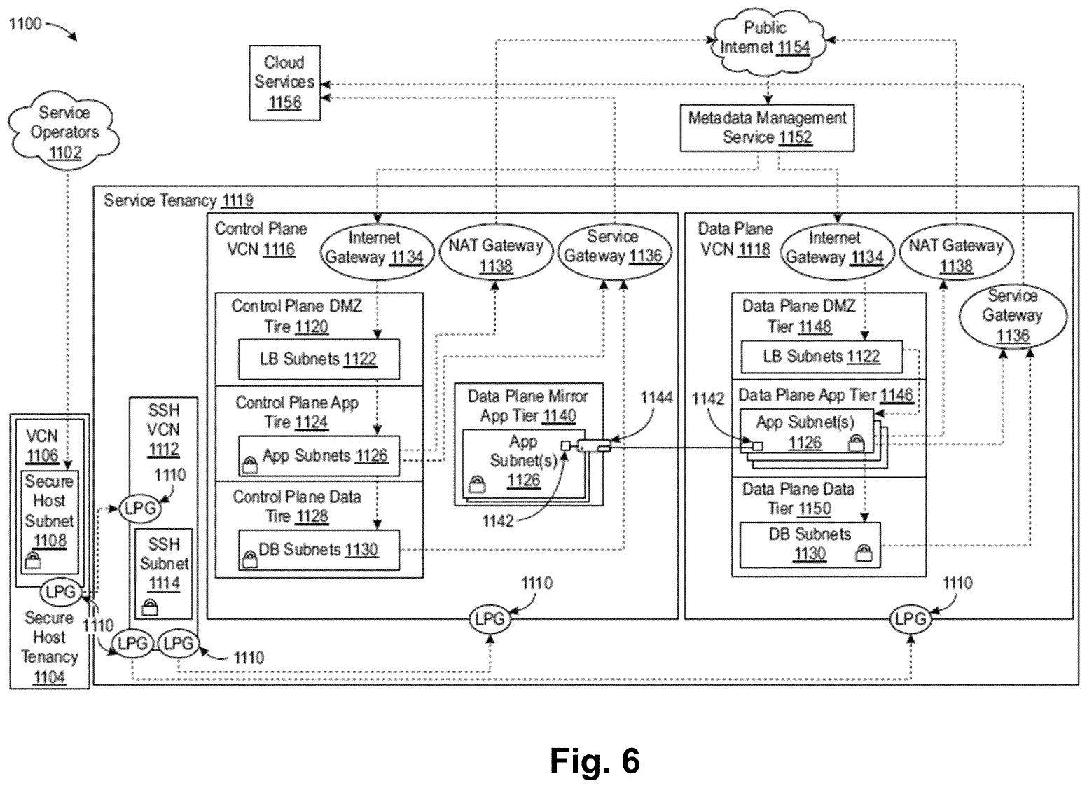

FIGS. 6-9 illustrate an example cloud infrastructure that can implement hotel chain operations 104 that can include overbooking modeling module 16 of FIG. 2 in accordance to embodiments.

As disclosed above, infrastructure as a service (“IaaS”) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (e.g., billing, monitoring, logging, security, load balancing and clustering, etc.). Thus, as these services may be policy-driven, IaaS users may be able to implement policies to drive load balancing to maintain application availability and performance.

In some instances, IaaS customers may access resources and services through a wide area network (“WAN”), such as the Internet, and can use the cloud provider's services to install the remaining elements of an application stack. For example, the user can log in to the IaaS platform to create virtual machines (“VM”s), install operating systems (“OS”s) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand)) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different problems for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (“VPC”s) (e.g., a potentially on-demand pool of configurable and/or shared computing resources), also known as a core network. In some examples, there may also be one or more security group rules provisioned to define how the security of the network will be set up and one or more virtual machines. Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

FIG. 6 is a block diagram 1100 illustrating an example pattern of an IaaS architecture, according to at least one embodiment. Service operators 1102 can be communicatively coupled to a secure host tenancy 1104 that can include a virtual cloud network (“VCN”) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (“PDA”)) or wearable devices (e.g., a Meta Quest® head mounted display), running software such as Microsoft Windows Mobile®, and/or a variety of mobile operating systems such as iOS, Windows Phone, Android, BlackBerry 8, Palm OS, and the like, and being Internet, e-mail, short message service (“SMS”), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (“LPG”) 1110 that can be communicatively coupled to a secure shell (“SSH”) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (“DMZ”) tier 1120 that acts as a perimeter network (e.g., portions of a corporate network between the corporate intranet and external networks). The DMZ-based servers may have restricted responsibilities and help keep security breaches contained. Additionally, the DMZ tier 1120 can include one or more load balancer (“LB”) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (“API”) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (“CRUD”) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Memory that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of security, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

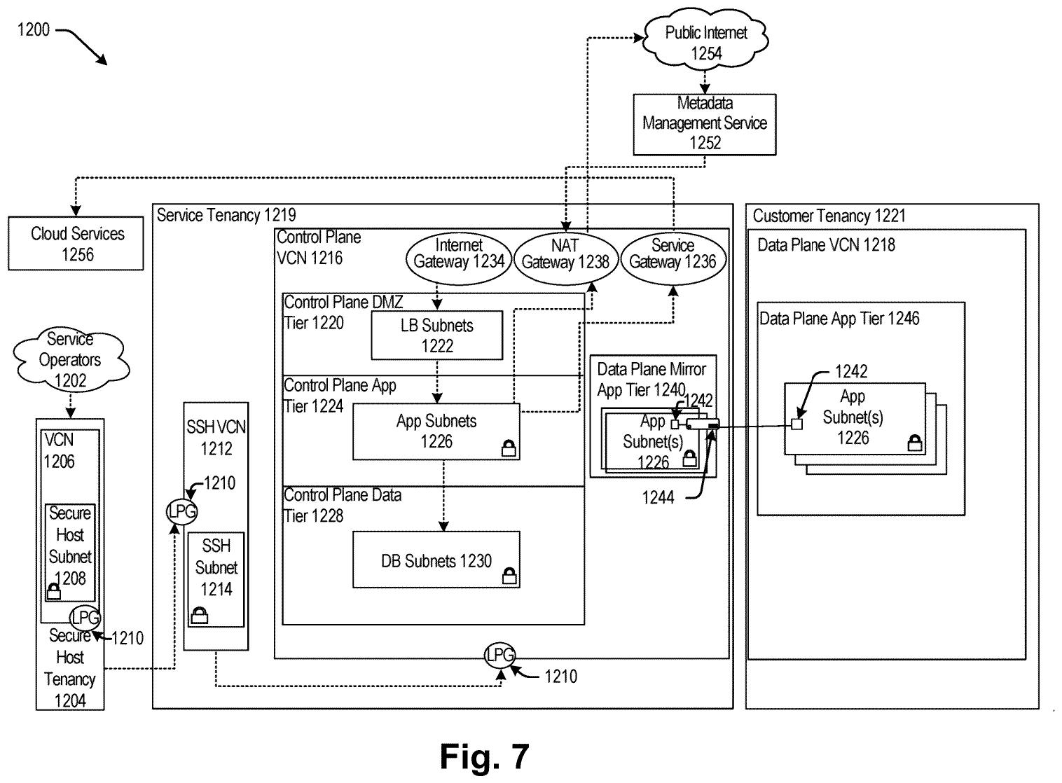

FIG. 7 is a block diagram 1200 illustrating another example pattern of an IaaS architecture, according to at least one embodiment. Service operators 1202 (e.g. service operators 1102) can be communicatively coupled to a secure host tenancy 1204 (e.g. the secure host tenancy 1104) that can include a virtual cloud network (VCN) 1206 (e.g. the VCN 1106) and a secure host subnet 1208 (e.g. the secure host subnet 1108). The VCN 1206 can include a local peering gateway (LPG) 1210 (e.g. the LPG 1110) that can be communicatively coupled to a secure shell (SSH) VCN 1212 (e.g. the SSH VCN 1112 10) via an LPG 1110 contained in the SSH VCN 1212. The SSH VCN 1212 can include an SSH subnet 1214 (e.g. the SSH subnet 1114), and the SSH VCN 1212 can be communicatively coupled to a control plane VCN 1216 (e.g. the control plane VCN 1116) via an LPG 1210 contained in the control plane VCN 1216. The control plane VCN 1216 can be contained in a service tenancy 1219 (e.g. the service tenancy 1119), and the data plane VCN 1218 (e.g. the data plane VCN 1118) can be contained in a customer tenancy 1221 that may be owned or operated by users, or customers, of the system.

The control plane VCN 1216 can include a control plane DMZ tier 1220 (e.g. the control plane DMZ tier 1120) that can include LB subnet(s) 1222 (e.g. LB subnet(s) 1122), a control plane app tier 1224 (e.g. the control plane app tier 1124) that can include app subnet(s) 1226 (e.g. app subnet(s) 1126), a control plane data tier 1228 (e.g. the control plane data tier 1128) that can include database (DB) subnet(s) 1230 (e.g. similar to DB subnet(s) 1130). The LB subnet(s) 1222 contained in the control plane DMZ tier 1220 can be communicatively coupled to the app subnet(s) 1226 contained in the control plane app tier 1224 and an Internet gateway 1234 (e.g. the Internet gateway 1134) that can be contained in the control plane VCN 1216, and the app subnet(s) 1226 can be communicatively coupled to the DB subnet(s) 1230 contained in the control plane data tier 1228 and a service gateway 1236 and a network address translation (NAT) gateway 1238 (e.g. the NAT gateway 1138). The control plane VCN 1216 can include the service gateway 1236 and the NAT gateway 1238.

The control plane VCN 1216 can include a data plane mirror app tier 1240 (e.g. the data plane mirror app tier 1140) that can include app subnet(s) 1226. The app subnet(s) 1226 contained in the data plane mirror app tier 1240 can include a virtual network interface controller (VNIC) 1242 (e.g. the VNIC of 1142) that can execute a compute instance 1244 (e.g. similar to the compute instance 1144). The compute instance 1244 can facilitate communication between the app subnet(s) 1226 of the data plane mirror app tier 1240 and the app subnet(s) 1226 that can be contained in a data plane app tier 1246 (e.g. the data plane app tier 1146) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g. the metadata management service 1152) that can be communicatively coupled to public Internet 1254 (e.g. public Internet 1154). Public Internet 1254 can be communicatively coupled to the NAT gateway 1238 contained in the control plane VCN 1216. The service gateway 1236 contained in the control plane VCN 1216 can be communicatively couple to cloud services 1256 (e.g. cloud services 1156).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218, but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 8,” may be located in Region 1 and in “Region 2.” If a call to Deployment 8 is made by the service gateway 1236 contained in the control plane VCN 1216 located in Region 1, the call may be transmitted to Deployment 8 in Region 1. In this example, the control plane VCN 1216, or Deployment 8 in Region 1, may not be communicatively coupled to, or otherwise in communication with, Deployment 8 in Region 2.

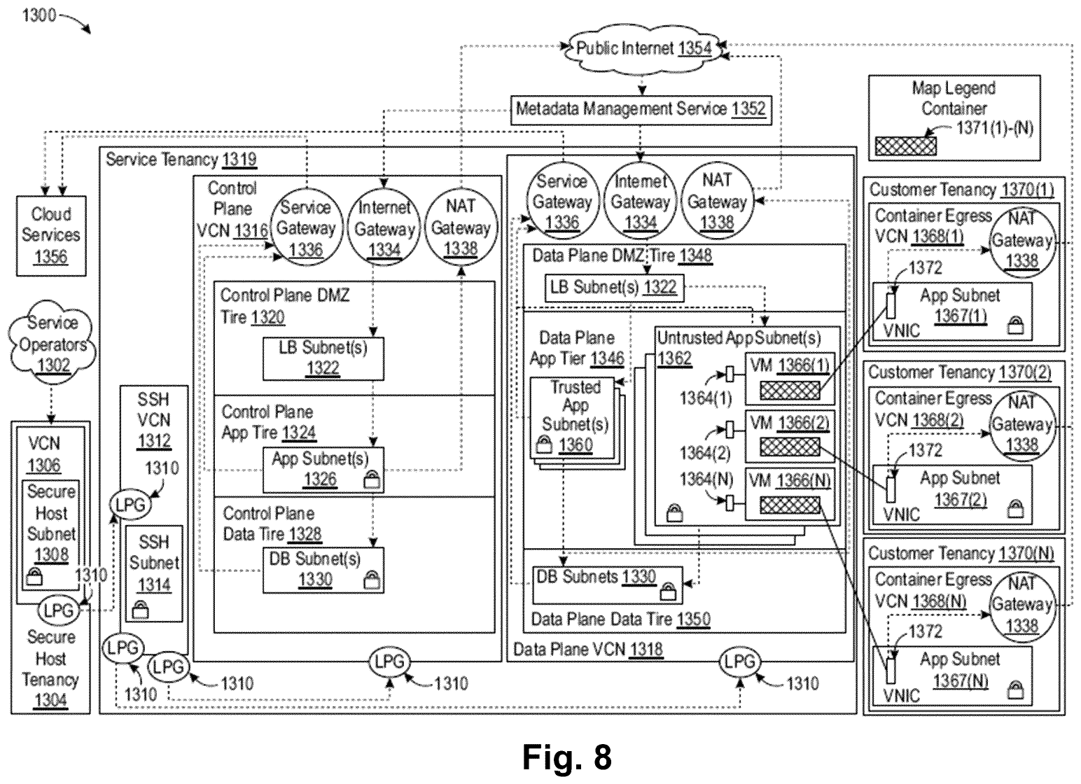

FIG. 8 is a block diagram 1300 illustrating another example pattern of an IaaS architecture, according to at least one embodiment. Service operators 1302 (e.g. service operators 1102) can be communicatively coupled to a secure host tenancy 1304 (e.g. the secure host tenancy 1104) that can include a virtual cloud network (VCN) 1306 (e.g. the VCN 1106) and a secure host subnet 1308 (e.g. the secure host subnet 1108). The VCN 1306 can include an LPG 1310 (e.g. the LPG 1110) that can be communicatively coupled to an SSH VCN 1312 (e.g. the SSH VCN 1112) via an LPG 1310 contained in the SSH VCN 1312. The SSH VCN 1312 can include an SSH subnet 1314 (e.g. the SSH subnet 1114), and the SSH VCN 1312 can be communicatively coupled to a control plane VCN 1316 (e.g. the control plane VCN 1116) via an LPG 1310 contained in the control plane VCN 1316 and to a data plane VCN 1318 (e.g. the data plane 1118) via an LPG 1310 contained in the data plane VCN 1318. The control plane VCN 1316 and the data plane VCN 1318 can be contained in a service tenancy 1319 (e.g. the service tenancy 1119).

The control plane VCN 1316 can include a control plane DMZ tier 1320 (e.g. the control plane DMZ tier 1120) that can include load balancer (“LB”) subnet(s) 1322 (e.g. LB subnet(s) 1122), a control plane app tier 1324 (e.g. the control plane app tier 1124) that can include app subnet(s) 1326 (e.g. similar to app subnet(s) 1126), a control plane data tier 1328 (e.g. the control plane data tier 1128) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g. the Internet gateway 1134) that can be contained in the control plane VCN 1316, and the app subnet(s) 1326 can be communicatively coupled to the DB subnet(s) 1330 contained in the control plane data tier 1328 and to a service gateway 1336 (e.g. the service gateway) and a network address translation (NAT) gateway 1338 (e.g. the NAT gateway 1138). The control plane VCN 1316 can include the service gateway 1336 and the NAT gateway 1338.

The data plane VCN 1318 can include a data plane app tier 1346 (e.g. the data plane app tier 1146), a data plane DMZ tier 1348 (e.g. the data plane DMZ tier 1148), and a data plane data tier 1350 (e.g. the data plane data tier 1150 of FIG. 10). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364 (1)-(N) that can be communicatively coupled to tenant virtual machines (VMs) 1366 (1)-(N). Each tenant VM 1366 (1)-(N) can be communicatively coupled to a respective app subnet 1367 (1)-(N) that can be contained in respective container egress VCNs 1368 (1)-(N) that can be contained in respective customer tenancies 1370 (1)-(N). Respective secondary VNICs 1372 (1)-(N) can facilitate communication between the untrusted app subnet(s) 1362 contained in the data plane VCN 1318 and the app subnet contained in the container egress VCNs 1368 (1)-(N). Each container egress VCNs 1368 (1)-(N) can include a NAT gateway 1338 that can be communicatively coupled to public Internet 1354 (e.g. public Internet 1154).

The Internet gateway 1334 contained in the control plane VCN 1316 and contained in the data plane VCN 1318 can be communicatively coupled to a metadata management service 1352 (e.g. the metadata management system 1152) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively couple to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane tier app 1346. Code to run the function may be executed in the VMs 1366 (1)-(N), and the code may not be configured to run anywhere else on the data plane VCN 1318. Each VM 1366 (1)-(N) may be connected to one customer tenancy 1370. Respective containers 1371 (1)-(N) contained in the VMs 1366 (1)-(N) may be configured to run the code. In this case, there can be a dual isolation (e.g., the containers 1371 (1)-(N) running code, where the containers 1371 (1)-(N) may be contained in at least the VM 1366 (1)-(N) that are contained in the untrusted app subnet(s) 1362), which may help prevent incorrect or otherwise undesirable code from damaging the network of the IaaS provider or from damaging a network of a different customer. The containers 1371 (1)-(N) may be communicatively coupled to the customer tenancy 1370 and may be configured to transmit or receive data from the customer tenancy 1370. The containers 1371 (1)-(N) may not be configured to transmit or receive data from any other entity in the data plane VCN 1318. Upon completion of running the code, the IaaS provider may kill or otherwise dispose of the containers 1371 (1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371 (1)-(N) that can be contained in the VM 1366 (1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

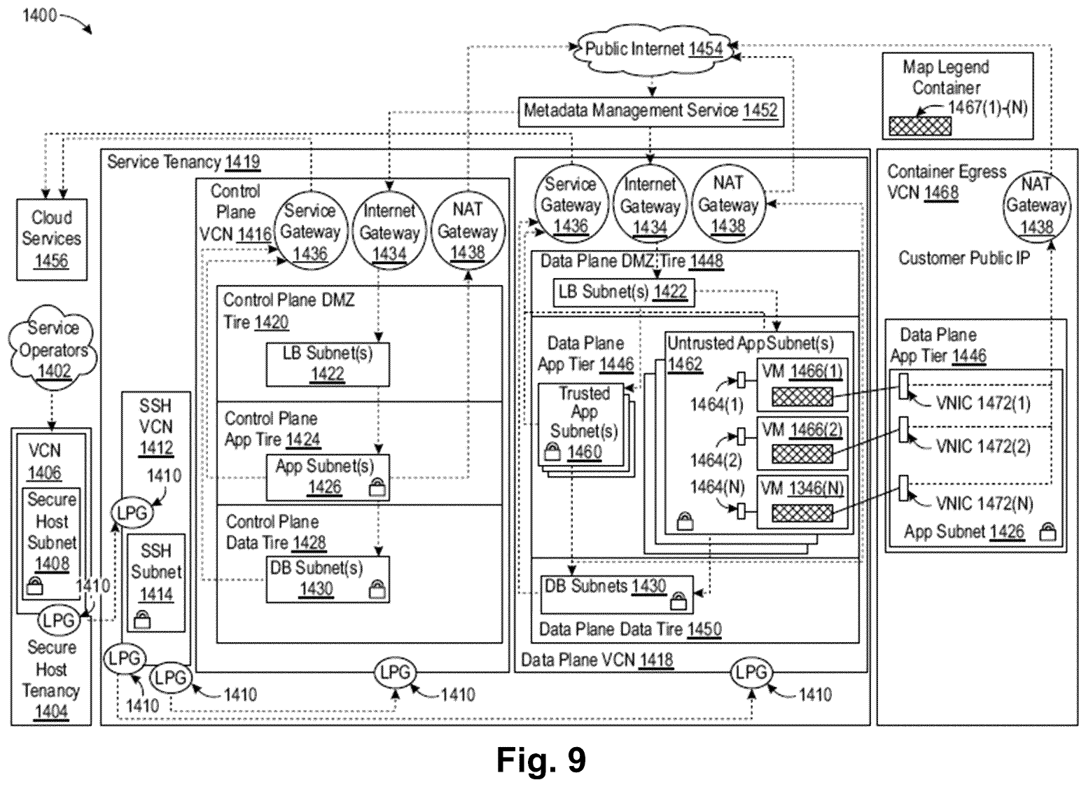

FIG. 9 is a block diagram 1400 illustrating another example pattern of an IaaS architecture, according to at least one embodiment. Service operators 1402 (e.g. service operators 1102) can be communicatively coupled to a secure host tenancy 1404 (e.g. the secure host tenancy 1104) that can include a virtual cloud network (“VCN”) 1406 (e.g. the VCN 1106) and a secure host subnet 1408 (e.g. the secure host subnet 1108). The VCN 1406 can include an LPG 1410 (e.g. the LPG 1110) that can be communicatively coupled to an SSH VCN 1412 (e.g. the SSH VCN 1112) via an LPG 1410 contained in the SSH VCN 1412. The SSH VCN 1412 can include an SSH subnet 1414 (e.g. the SSH subnet 1114), and the SSH VCN 1412 can be communicatively coupled to a control plane VCN 1416 (e.g. the control plane VCN 1116) via an LPG 1410 contained in the control plane VCN 1416 and to a data plane VCN 1418 (e.g. the data plane 1118) via an LPG 1410 contained in the data plane VCN 1418. The control plane VCN 1416 and the data plane VCN 1418 can be contained in a service tenancy 1419 (e.g. the service tenancy 1119).

The control plane VCN 1416 can include a control plane DMZ tier 1420 (e.g. the control plane DMZ tier 1120) that can include LB subnet(s) 1422 (e.g. LB subnet(s) 1122), a control plane app tier 1424 (e.g. the control plane app tier 1124) that can include app subnet(s) 1426 (e.g. app subnet(s) 1126), a control plane data tier 1428 (e.g. the control plane data tier 1128) that can include DB subnet(s) 1430 (e.g. DB subnet(s) 1330). The LB subnet(s) 1422 contained in the control plane DMZ tier 1420 can be communicatively coupled to the app subnet(s) 1426 contained in the control plane app tier 1424 and to an Internet gateway 1434 (e.g. the Internet gateway 1134) that can be contained in the control plane VCN 1416, and the app subnet(s) 1426 can be communicatively coupled to the DB subnet(s) 1430 contained in the control plane data tier 1428 and to a service gateway 1436 (e.g. the service gateway of FIG. 10) and a network address translation (NAT) gateway 1438 (e.g. the NAT gateway 1138 of FIG. 10). The control plane VCN 1416 can include the service gateway 1436 and the NAT gateway 1438.

The data plane VCN 1418 can include a data plane app tier 1446 (e.g. the data plane app tier 1146), a data plane DMZ tier 1448 (e.g. the data plane DMZ tier 1148), and a data plane data tier 1450 (e.g. the data plane data tier 1150). The data plane DMZ tier 1448 can include LB subnet(s) 1422 that can be communicatively coupled to trusted app subnet(s) 1460 (e.g. trusted app subnet(s) 1360) and untrusted app subnet(s) 1462 (e.g. untrusted app subnet(s) 1362) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464 (1)-(N) that can be communicatively coupled to tenant virtual machines (VMs) 1466 (1)-(N) residing within the untrusted app subnet(s) 1462. Each tenant VM 1466 (1)-(N) can run code in a respective container 1467 (1)-(N), and be communicatively coupled to an app subnet 1426 that can be contained in a data plane app tier 1446 that can be contained in a container egress VCN 1468. Respective secondary VNICs 1472 (1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g. public Internet 1154).

The Internet gateway 1434 contained in the control plane VCN 1416 and contained in the data plane VCN 1418 can be communicatively coupled to a metadata management service 1452 (e.g. the metadata management system 1152) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively couple to cloud services 1456.

In some examples, the pattern illustrated by the architecture of block diagram 1400 of FIG. 9 may be considered an exception to the pattern illustrated by the architecture of block diagram 1300 of FIG. 8 and may be desirable for a customer of the IaaS provider if the IaaS provider cannot directly communicate with the customer (e.g., a disconnected region). The respective containers 1467 (1)-(N) that are contained in the VMs 1466 (1)-(N) for each customer can be accessed in real-time by the customer. The containers 1467 (1)-(N) may be configured to make calls to respective secondary VNICs 1472 (1)-(N) contained in app subnet(s) 1426 of the data plane app tier 1446 that can be contained in the container egress VCN 1468. The secondary VNICs 1472 (1)-(N) can transmit the calls to the NAT gateway 1438 that may transmit the calls to public Internet 1454. In this example, the containers 1467 (1)-(N) that can be accessed in real-time by the customer can be isolated from the control plane VCN 1416 and can be isolated from other entities contained in the data plane VCN 1418. The containers 1467 (1)-(N) may also be isolated from resources from other customers.

In other examples, the customer can use the containers 1467 (1)-(N) to call cloud services 1456. In this example, the customer may run code in the containers 1467 (1)-(N) that requests a service from cloud services 1456. The containers 1467 (1)-(N) can transmit this request to the secondary VNICs 1472 (1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate certain embodiments. In some other embodiments, the IaaS systems may have more or fewer components than shown in the figures, may combine two or more components, or may have a different configuration or arrangement of components.

As disclosed, embodiments solve overbooking issues with a hotel operation with multiple room categories. Every two room categories can either be compared in the sense that one of them is better than the other (e.g., larger room, bigger beds, better view, etc.) or they cannot be compared as in the case when one room category has a better view but smaller room size than the other. If one room category is better than the other, a guest can be upgraded from the basic category to the premium category when the basic category is overbooked or the guest agrees to pay an upgrade fee. If the premium category is underbooked, this mechanism allows the hotel to overbook the basic category.

However, overbooking the basic category too aggressively may lead to revenue loss when later reservations in the premium category are blocked by earlier upgrades from the basic category. Therefore, certain revenue protection mechanisms should be imposed to limit the number of bookings in the basic category even when there is a space currently available in the premium category. As a significant number of hotel reservations are canceled, the entire hotel booking limits may exceed the total number of rooms by accepting a small risk of denying a room to a guest.

In embodiments, the stochastic nature of the problem is addressed by formulating it as a robust optimization to guarantee optimal performance in the worst-case scenario and to account for the error in estimating the cancellation probability. The decision variables of the problem are daily booking limits for each hotel room category and assignment variables expressing the upgrading policy for each day of the operation. The optimization objective is the total profit defined as the difference between the revenue collected from booking the reservations and the costs of downgrading the hotel guests. The main constraints are the limits of the per-category room inventory.

Embodiments include a model for hotel revenue management that accommodates multiple room types and multiple-day bookings. The model utilizes a two-stage optimization framework. On each day, in the first stage, referred to as the reservation stage, the decision variables are the overbooking limits designated for each room type. Subsequently, in the second stage, also known as the service stage, embodiments include assignment decision variables representing the upgrading policy. These variables are adaptive and depend upon the realized demand and cancellations. Therefore, they provide the flexibility to respond dynamically to the actual outcomes of customer behavior. Moreover, the model considers the worst-case no-show and cancellation scenario, which is solved by the robust optimization.

Specifically, embodiments employ a linear decision rule to transition from a two-stage optimization problem to a more manageable single stage. To address the probabilistic nature of customer cancellations and no-shows, embodiments leverage specific probabilistic concentration inequalities, constructing polyhedrons that encapsulate the uncertainty associated with these random variables. With this, embodiments introduce a theoretical adversary, tasked with minimizing the total revenue by selecting values for the random variables within the specified uncertainty region. This leads to the derivation of the “robust counterpart” for each constraint. Specifically, the robust counterpart is a version of the original constraint without random variables. Still, it preserves its integrity by incorporating the influence of both the adversary and the uncertainty polyhedron region. These robust counterparts are equivalently expressed as linear equations, resulting in a linear optimization problem. Finally, the linear optimization problem is solved by one of the standard linear programming solvers widely available in the industry.

In contrast to known solutions, embodiments uniquely integrate four key components: (1) optimization of booking limits; (2) addressing the variability inherent in customer show-up rates; (3) a dynamic upgrading policy tailored to observed demand; and (4) considerations for multi-day stays. While some known solutions address these factors in isolation, their interdependencies, such as how a particular upgrading policy may alter the optimal booking limit, mean that these known solutions fall short of addressing this combined challenge.

The comprehensive adaptive robust optimization framework in embodiments seamlessly integrates all variables while accounting for the intricate interplay between the components of the problem. This approach of developing an optimization approach concurrently solves several problems that normally present significant analytical challenges. Embodiments translate the original robust optimization problem into a nearly equivalent linear programming formulation.

The features, structures, or characteristics of the disclosure described throughout this specification may be combined in any suitable manner in one or more embodiments. For example, the usage of “one embodiment,” “some embodiments,” “certain embodiment,” “certain embodiments,” or other similar language, throughout this specification refers to the fact that a particular feature, structure, or characteristic described in connection with the embodiment may be included in at least one embodiment of the present disclosure. Thus, appearances of the phrases “one embodiment,” “some embodiments,” “a certain embodiment,” “certain embodiments,” or other similar language, throughout this specification do not necessarily all refer to the same group of embodiments, and the described features, structures, or characteristics may be combined in any suitable manner in one or more embodiments.

One having ordinary skill in the art will readily understand that the embodiments as discussed above may be practiced with steps in a different order, and/or with elements in configurations that are different than those which are disclosed. Therefore, although this disclosure considers the outlined embodiments, it would be apparent to those of skill in the art that certain modifications, variations, and alternative constructions would be apparent, while remaining within the spirit and scope of this disclosure. In order to determine the metes and bounds of the disclosure, therefore, reference should be made to the appended claims.

What is claimed is:

1. A method of optimizing hotel room reservations for a hotel, the method comprising:
for a first day of a plurality of future days, automatically determining, based on an objective function, an overbooking limit for each category of hotel rooms for the hotel, wherein the hotel includes a plurality of different room categories;
receiving a first reservation request for the first day for a first category room;
when the determined overbooking limit for the first category room has not been reached, accepting the first reservation request;
when the accepted first reservation request is being checked in to the hotel on the first day, automatically determining a check in decision, based on the objective function, to reject the first reservation request, accept the first reservation request, or upgrade the first reservation request to a higher category room.

2. The method of claim 1, further comprising determining the overbooking limit for a sequence of the plurality of future days.

3. The method of claim 1, further comprising generating a prediction of new reservations for the plurality of future days using a first machine learning model.

4. The method of claim 1, further comprising generating a prediction of cancellations of existing reservations using a second machine learning model.

5. The method of claim 1, further comprising:
generating a mixed integer optimization problem (MILP) that models the overbooking limit and models the check in decision; and
converting the MILP into a linear optimization problem using a polyhedron uncertainty set for a total number of arriving customers to the hotel.

6. The method of claim 5, wherein the MILP comprises a plurality of random variables, the polyhedron uncertainty set eliminating the random variables.

7. The method of claim 6, wherein the linear optimization problem comprises a plurality of constraints that comprises uncertainty, further comprising formulating a robust counterpart without random variables for each of the plurality of constraints.

8. The method of claim 1, further comprising:
in response to the check in decision, automatically encoding a corresponding hotel room key.

9. A computer readable medium having instructions stored thereon that, when executed by one or more processors, cause the processors to optimize hotel room reservations for a hotel, the optimizing comprising:
for a first day of a plurality of future days, automatically determining, based on an objective function, an overbooking limit for each category of hotel rooms for the hotel, wherein the hotel includes a plurality of different room categories;
receiving a first reservation request for the first day for a first category room;
when the determined overbooking limit for the first category room has not been reached, accepting the first reservation request;
when the accepted first reservation request is being checked in to the hotel on the first day, automatically determining a check in decision, based on the objective function, to reject the first reservation request, accept the first reservation request, or upgrade the first reservation request to a higher category room.

10. The computer readable medium of claim 9, the optimizing further comprising determining the overbooking limit for a sequence of the plurality of future days.

11. The computer readable medium of claim 9, the optimizing further comprising generating a prediction of new reservations for the plurality of future days using a first machine learning model.

12. The computer readable medium of claim 9, the optimizing further comprising generating a prediction of cancellations of existing reservations using a second machine learning model.

13. The computer readable medium of claim 9, the optimizing further comprising:
generating a mixed integer optimization problem (MILP) that models the overbooking limit and models the check in decision; and
converting the MILP into a linear optimization problem using a polyhedron uncertainty set for a total number of arriving customers to the hotel.

14. The computer readable medium of claim 13, wherein the MILP comprises a plurality of random variables, the polyhedron uncertainty set eliminating the random variables.

15. The computer readable medium of claim 14, wherein the linear optimization problem comprises a plurality of constraints that comprises uncertainty, further comprising formulating a robust counterpart without random variables for each of the plurality of constraints.

16. The computer readable medium of claim 9, the optimizing further comprising:
in response to the check in decision, automatically encoding a corresponding hotel room key.

17. A cloud based hotel reservation system that optimizes hotel room reservations for a hotel, the system comprising:
one or more processors adapted to:
for a first day of a plurality of future days, automatically determine, based on an objective function, an overbooking limit for each category of hotel rooms for the hotel, wherein the hotel includes a plurality of different room categories;
receive a first reservation request for the first day for a first category room;
when the determined overbooking limit for the first category room has not been reached, accept the first reservation request;
when the accepted first reservation request is being checked in to the hotel on the first day, automatically determine a check in decision, based on the objective function, to reject the first reservation request, accept the first reservation request, or upgrade the first reservation request to a higher category room.

18. The system of claim 17, the processors further determining the overbooking limit for a sequence of the plurality of future days.

19. The system of claim 17, further comprising a first trained machine learning model and generating a prediction of new reservations for the plurality of future days using the first trained machine learning model.

20. The system of claim 17, further comprising a second trained machine learning model and generating a prediction of cancellations of existing reservations using the second trained machine learning model.
